(19) United States
(12) Patent Application Publication
(10) Pub. No.: US 2026/0349295 A1
(43) Pub. Date: Nov. 5, 2026

(54) MOUNTING BRACKET AND DISPLAY APPARATUS INCLUDING THE SAME

(71) Applicant: SAMSUNG ELECTRONICS CO., LTD., Suwon-si (KR)

(72) Inventors: Jin PARK, Suwon-si (KR); Hosuk CHAE, Suwon-si (KR); Sehwan IN, Suwon-si (KR); Sungyong PARK, Suwon-si (KR); Junki NOH, Suwon-si (KR); Heejae KIM, Suwon-si (KR)

(73) Assignee: SAMSUNG ELECTRONICS CO., LTD., Suwon-si (KR)

(21) Appl. No.: 19/712,981

(22) Filed: Jun. 18, 2026

Related U.S. Application Data
(63) Continuation of application No. PCT/KR2026/001502, filed on Jan. 26, 2026.

(30) Foreign Application Priority Data
Mar. 21, 2025 (KR) 10-2025-0036875

(51) Int. Cl. G02F 1/1333; F16M 13/02

(52) U.S. Cl. CPC G02F 1/133314; F16M 13/02

(57) ABSTRACT

A display apparatus includes a display panel, a rear chassis supporting the display panel. The rear chassis includes a rear cover covering a rear side of the display panel, and a side cover protruding from an edge of the rear cover and covering an edge of the display panel, and a mounting bracket mounted on the rear chassis. The mounting bracket includes, a bracket body on an outer surface of the side cover, a hook portion protruding from a first end of the bracket body and to receive a portion of the side cover, and a fixing protrusion protruding from a second end of the bracket body and to contact a rear surface of the rear cover to fix the mounting bracket to the rear chassis.

### CROSS-REFERENCE TO RELATED APPLICATIONS

This application is a Continuation Application of International Application No. PCT/KR2026/001502 filed on Jan. 26, 2026, which claims priority to Korean Patent Application No. 10-2025-0036875, filed on Mar. 21, 2025, at the Korean Ministry of Intellectual Property, the disclosures of which are incorporated herein in their entireties by reference.

### BACKGROUND

### 1. Field

The present disclosure relates to a mounting bracket and a display apparatus including the same.

### 2. Description of the Related Art

A display apparatus is a type of output device that converts obtained or stored electrical information into visual information and displays the visual information to a user.

The display apparatus may include a self-emissive display panel such as an organic light-emitting diode (OLED) or a non-self-emissive display panel such as a liquid crystal display (LCD).

A display apparatus including the non-self-emissive display panel may include a rear chassis supporting a display panel and a backlight unit disposed between the display panel and the rear chassis so as to supply light to the display panel.

### SUMMARY

Provided are a mounting bracket mounted to a rear chassis, and a display apparatus including the same.

Further, provided are a mounting bracket capable of preventing a display panel from colliding with a rear chassis, and a display apparatus including the same.

Further, provided are a mounting bracket capable of guiding a display panel to be seated in a correct position during a manufacturing process of the display panel, and a display apparatus including the same.

Additional aspects of the disclosure will be set forth in part in the description which follows and, in part, will be obvious from the description, or may be learned by practice of the disclosure.

According to an aspect of the disclosure, a display apparatus includes: a display panel; a rear chassis supporting the display panel, wherein the rear chassis includes: a rear cover covering a rear side of the display panel, and a side cover protruding from an edge of the rear cover and covering an edge of the display panel; and a mounting bracket mounted on the rear chassis, wherein the mounting bracket includes: a bracket body on an outer surface of the side cover; a hook portion protruding from a first end of the bracket body and configured to receive a portion of the side cover; and a fixing protrusion protruding from a second end of the bracket body and configured to contact a rear surface of the rear cover to fix the mounting bracket to the rear chassis.

The fixing protrusion may include an inclined portion extending obliquely from the second end of the bracket body.

The fixing protrusion may further include a protrusion protruding from the inclined portion toward the rear surface of the rear cover.

The protrusion may protrude from one end portion of the inclined portion in a direction in which the inclined portion extends.

The hook portion may include: an extension portion extending from an end of the bracket body in a first direction; a first bent portion extending from the extension portion in a second direction intersecting the first direction; and a second bent portion extending from the first bent portion in a third direction parallel to the first direction, the extension portion, the first bent portion, and the second bent portion may define a cover insertion space configured to receive the one end of the side cover, and the second bent portion may be between the display panel and the one end of the side cover.

The mounting bracket may be detachably mounted to the rear chassis.

The mounting bracket may be mounted on a corner of the rear chassis.

The side cover may include: a first cover portion extending in a first direction; and a second cover portion connected to the first cover portion and extending in a second direction intersecting the first direction, and the bracket body may include: a first body on an outer surface of the first cover portion; and a second body extending from the first body and provided on an outer surface of the second cover portion.

The display apparatus may further include: an optical sheet between the display panel and the rear chassis; and a fixing bracket coupled to the rear chassis and configured to fix the optical sheet to the rear chassis, the fixing bracket defining a sheet insertion space configured to receive at least a portion of the optical sheet.

The rear chassis may include a bracket support portion connected to a portion of the side cover that covers an upper edge of the display panel and supports the fixing bracket, and the bracket support portion, the portion of the side cover, and the rear cover may define an insertion groove configured to receive the fixing bracket.

The fixing bracket may include: a first portion on an inner surface of the side cover; a second portion extending from a first end of the first portion and contacting the bracket support portion; and a third portion extending from a second end of the first portion and contacting a surface of the rear cover.

The third portion extends obliquely from the second end of the first portion.

The fixing bracket further may include an insertion protrusion extending from the second portion toward the bracket support portion, and the bracket support portion may include an insertion hole configured to receive the insertion protrusion.

The fixing bracket further may include an insertion protrusion extending from the second portion toward the optical sheet, and the optical sheet may include an insertion hole configured to receive the insertion protrusion.

The insertion protrusion may extend obliquely upward from the second portion

### DESCRIPTION OF DRAWINGS

FIG. 1 is a perspective view of a display apparatus according to one embodiment.

FIG. 2 is an exploded-perspective view of the display apparatus according to one embodiment.

FIG. 3 is a perspective view illustrating a state in which a chassis reinforcing member, a mounting bracket, and a fixing bracket are disassembled from a rear chassis according to one embodiment.

FIG. 4 is an enlarged perspective view illustrating a state in which the rear chassis and the chassis reinforcing member are coupled according to one embodiment.

FIG. 5 is a perspective view of the chassis reinforcing member according to one embodiment.

FIG. 6 is an enlarged perspective view of a region A shown in FIG. 1.

FIG. 7 is a perspective view of the mounting bracket according to one embodiment.

FIG. 8 is an enlarged rear perspective view of the region A shown in FIG. 1.

FIG. 9 is a rear perspective view of the mounting bracket according to one embodiment.

FIG. 10 is a cross-sectional view taken along line B-B′ shown in FIG. 6.

FIG. 11 is a cross-sectional view taken along line C-C′ shown in FIG. 6.

FIG. 12 is a perspective view of a display apparatus according to one embodiment.

FIG. 13 is an enlarged perspective view of a region D shown in FIG. 12.

FIG. 14 is a perspective view of a display apparatus according to one embodiment.

FIG. 15 is an enlarged perspective view of a region E shown in FIG. 14.

FIG. 16 is an exploded perspective view of the display apparatus according to one embodiment.

FIG. 17 is an enlarged perspective view of a region F shown in FIG. 16.

FIG. 18 is an exploded perspective view of some components of the display apparatus illustrated in FIG. 17.

FIG. 19 is a perspective view illustrating a fixing bracket according to one embodiment.

FIG. 20 is a cross-sectional view taken along line I-I′ shown in FIG. 19.

FIG. 21 is a cross-sectional view taken along line G-G′ shown in FIG. 17.

FIG. 22 is a cross-sectional view taken along line H-H′ shown in FIG. 17.

FIG. 23 is a view illustrating a process of assembling the rear chassis, a light source module, the chassis reinforcing member, and a reflective sheet according to one embodiment.

FIG. 24 is a view illustrating a process of assembling the fixing bracket according to one embodiment.

FIG. 25 is a perspective view illustrating a bracket jig and the fixing bracket according to one embodiment.

FIG. 26 is a view illustrating a process of assembling a diffuser plate according to one embodiment.

FIG. 27 is an enlarged perspective view of a region J shown in FIG. 26.

FIG. 28 is an enlarged perspective view of a region K shown in FIG. 26.

FIG. 29 is a view illustrating a process of assembling the reflective sheet according to one embodiment.

FIG. 30 is a view illustrating a process of assembling an adhesive member and the mounting bracket according to one embodiment.

FIG. 31 is a view illustrating a process of assembling a display panel and a lower cover according to one embodiment.

### DETAILED DESCRIPTION

The various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (importance or order) of elements.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element, or any number of additional elements.

Throughout the description, when an element is “on” another element, this includes not only when the element is in contact with the other element, but also when there is another element, or any number of additional elements, between the two elements.

In the following detailed description, the terms of “front surface”, “rear surface”, “upper surface”, “lower surface”, “side surface”, “left side”, “upper side”, “upper portion”, “lower portion” and the like may be defined by the drawings, but the shape and the location of the element is not limited by the term.

For example, an X direction may be defined as a front and rear direction. For example, a Y direction may be defined as a lateral direction. For example, a Z direction may be defined as an up and down direction. For example, a +X direction may be defined as a front direction and a −X direction may be defined as a rear direction. For example, a +Y direction may be defined as a left direction and a −Y direction may be defined as the right direction. For example, a +Z direction may be defined as an upper direction and a −Z direction may be defined as a lower direction.

Hereinafter, example embodiments of the present disclosure will be described in detail with reference to the accompanying drawings.

In addition, for convenience of description, a liquid crystal display (LCD) apparatus, which is a type of display apparatus, is described below as an example, but a configuration of the present disclosure is not limited to an LCD apparatus and may be applied to various types of display apparatus. For example, the configuration of the present disclosure may also be applied to an organic light emitting diode (OLED) display apparatus that does not include a backlight unit. Further, the configuration of the present disclosure may also be applied to a micro-LED display apparatus.

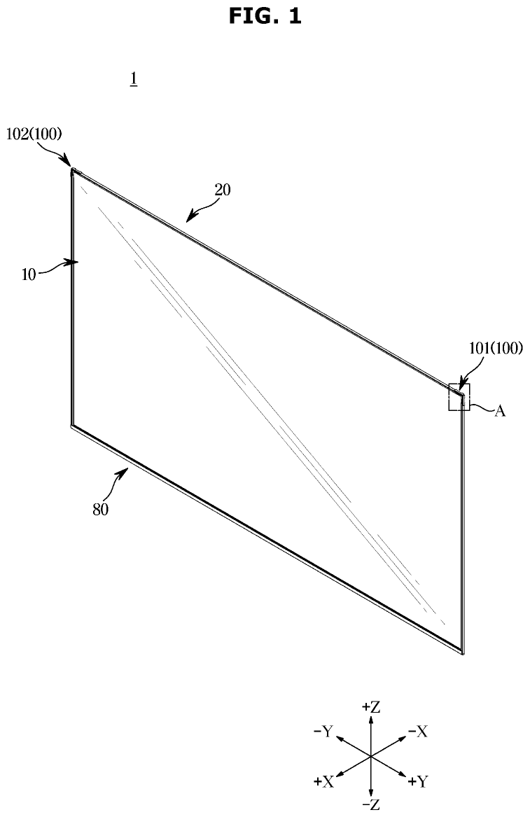

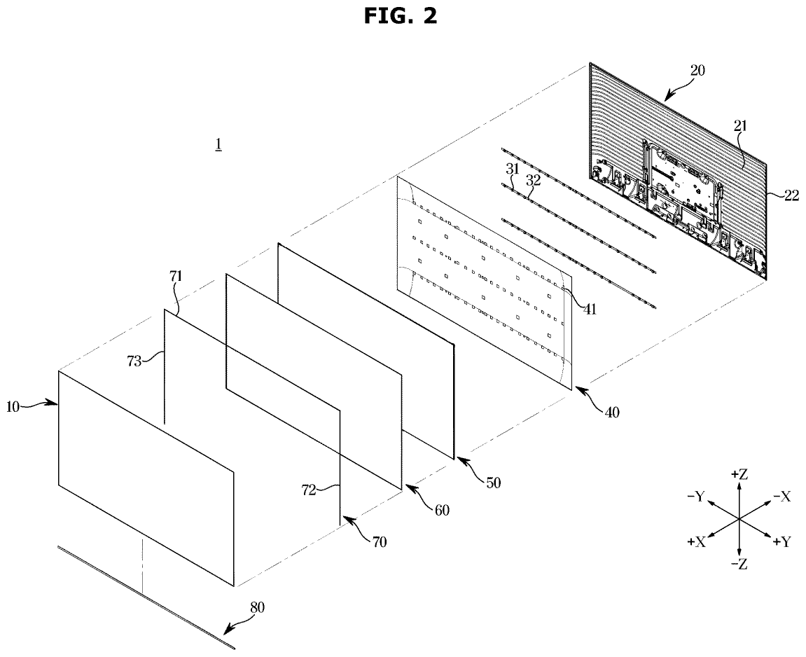

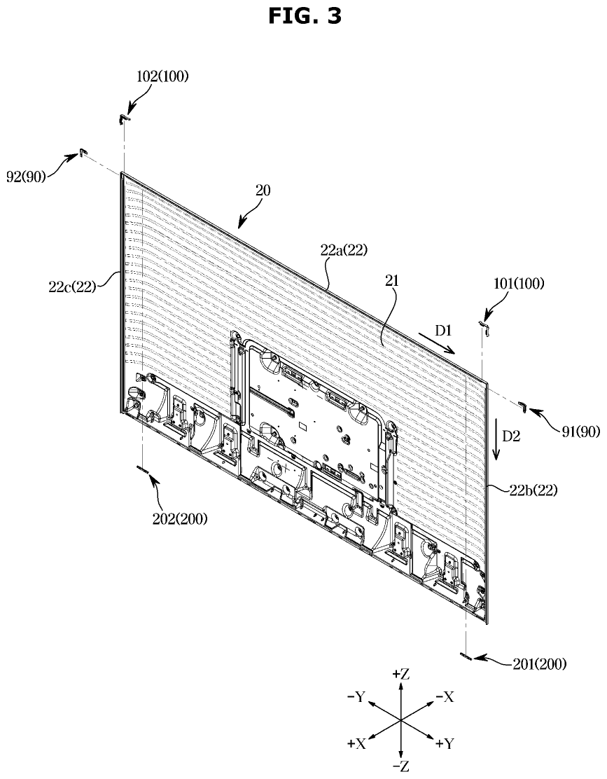

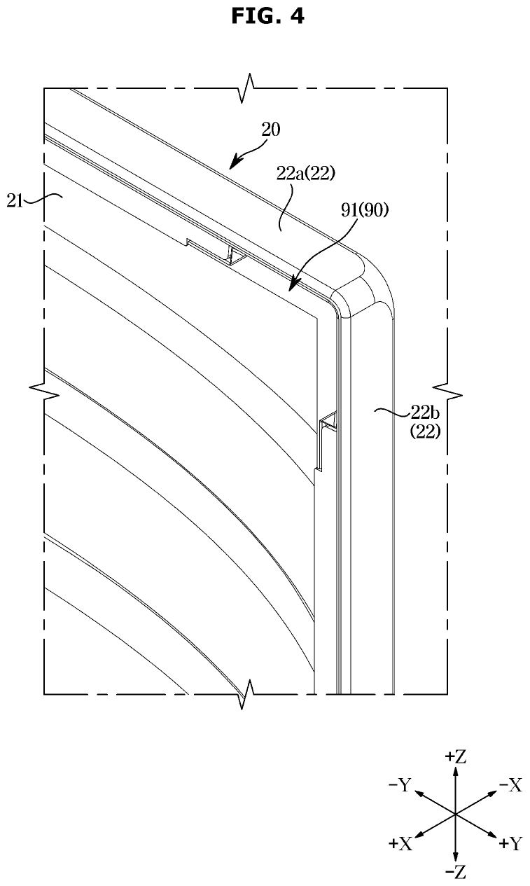

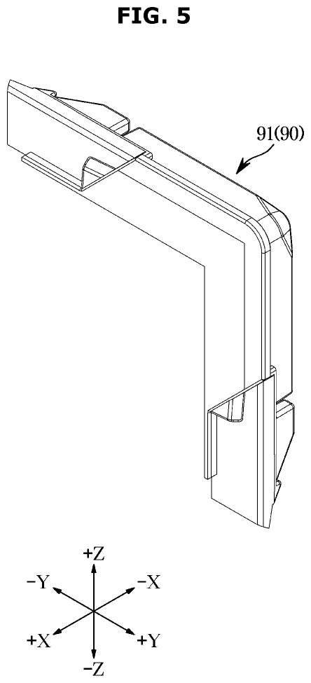

FIG. 1 is a perspective view of a display apparatus according to one embodiment. FIG. 2 is an exploded-perspective view of the display apparatus according to one embodiment. FIG. 3 is a perspective view illustrating a state in which a chassis reinforcing member, a mounting bracket, and a fixing bracket are disassembled from a rear chassis according to one embodiment. FIG. 4 is an enlarged perspective view illustrating a state in which the rear chassis and the chassis reinforcing member are coupled according to one embodiment. FIG. 5 is a perspective view of the chassis reinforcing member according to one embodiment.

Referring to FIGS. 1 to 5, a display apparatus 1 is a device that processes an image signal received from an outside and visually displays the processed image. Hereinafter a case in which the display apparatus 1 is a television is exemplified, but the disclosure is not limited thereto. For example, the display apparatus 1 may be implemented in various forms, such as a monitor, a portable multimedia device, and a portable communication device, and the display apparatus 10 is not limited in its shape as long as it visually displays an image.

The display apparatus 1 may be a large format display (LFD) installed outdoors, such as a roof of a building or a bus stop. The outdoor is not limited to the outside of a building, and thus the display apparatus 1 according to one embodiment may be installed in any place as long as the display apparatus is accessed by a large number of people, even indoors, such as subway stations, shopping malls, movie theaters, companies, and stores.

The display apparatus 1 may receive content data including video data and audio data from various content sources and output video and audio corresponding to the video data and the audio data. For example, the display apparatus 1 may receive content data through a broadcast reception antenna or cable, receive content data from a content playback device, or receive content data from a content providing server of a content provider.

The display apparatus 1 may include a display panel 10. The display panel 10 may be provided to display an image. The display panel 10 illustrated in FIGS. 1 and 2 has a flat shape, but the display panel 10 may also have a curved shape.

The display apparatus 1 may include a backlight unit (BLU). The backlight unit may be arranged at a rear side of the display panel 10 to provide light to the display panel 10.

The display apparatus 1 may include a rear chassis 20. The rear chassis 20 may be arranged at the rear side of the display panel 10. The rear chassis 20 may cover the rear side of the display panel 10. The rear chassis 20 may be provided to support the display panel 10.

The rear chassis 20 may be provided to support various components of the backlight unit. For example, the rear chassis 20 may support a reflective sheet 40, a diffuser plate 50, and an optical sheet 60 to be described later.

The rear chassis 20 may include a rear cover 21. The rear cover 21 may cover the rear side of the display panel 10. The rear cover 21 may be provided at the rear side of the display panel 10.

The rear chassis 20 may include a side cover 22. The side cover 22 may cover an edge of the display panel 10. The side cover 22 may be provided on an outer side of the edge of the display panel 10. The side cover 22 may protrude forward from the edge of the rear cover 21.

The side cover 22 may include a plurality of cover portions 22a, 22b, and 22c. Each of the plurality of cover portions 22a, 22b, and 22c may extend in one direction. For example, the plurality of cover portions 22a, 22b, and 22c may include a first cover portion 22a, a second cover portion 22b, and a third cover portion 22c.

The first cover portion 22a may cover an upper edge (+Z direction) of the display panel 10. The first cover portion 22a may extend along a first direction D1. For example, the first cover portion 22a may extend along the left and right direction (Y-axis direction).

The second cover portion 22b may cover a left edge (+Y direction) of the display panel 10. The second cover portion 22b may extend along a second direction D2 intersecting the first direction D1. For example, the second cover portion 22b may extend along the up and down direction (Z-axis direction).

The third cover portion 22c may cover a right edge (−Y direction) of the display panel 10. The third cover portion 22c may extend along the second direction D2 intersecting the first direction D1. For example, the third cover portion 22c may extend along the up and down direction (Z-axis direction).

The first cover portion 22a, the second cover portion 22b, and the third cover portion 22c may be connected to each other. That is, the first cover portion 22a, the second cover portion 22b, and the third cover portion 22c may be formed integrally with each other.

The backlight unit may include a light source module 30. The light source module 30 may be configured to generate light and provide the light to the display panel 10. The light source module 30 may be positioned at the rear side of the display panel 10.

The light source module 30 may be provided on a front surface of the rear chassis 20. Particularly, the light source module 30 may be provided on a front surface of the rear cover 21.

The light source module 30 may include a light source 31 and a substrate 32 on which the light source 31 is mounted. Each of the light sources 31 and the substrates 32 may be provided in multiple numbers. For example, a plurality of light sources 31 may be arranged spaced apart from each other on a single substrate 32, and a plurality of substrates 32 may be arranged spaced apart from each other on the front surface of the rear chassis 20. However, there is no particular limitation on the arrangement method of each of the plurality of light sources 31 and the plurality of substrates 32.

The backlight unit may include the reflective sheet 40. The reflective sheet 40 may be provided to reflect light emitted from the light source 31. Particularly, the reflective sheet 40 may reflect light emitted from the light source 31 to a front side or a direction close to the front side.

The reflective sheet 40 may be provided on the front surface of the rear chassis 20. Particularly, the reflective sheet 40 may be provided on the front surface of the rear cover 21.

The reflective sheet 40 may include a through hole 41. The through hole 41 may be formed at a position corresponding to the light source 31. The light source 31 may be provided to penetrate the through hole 41, and at least a portion of the light source 31 may protrude forward of the reflective sheet 40.

A plurality of through holes 41 may be provided. The number of through holes 41 may correspond to the number of light sources 31.

The backlight unit may include the diffuser plate 50. The diffuser plate 50 may be positioned on a front side of the reflective sheet 40. The diffuser plate 50 may be supported by the rear chassis 20.

The diffuser plate 50 may be provided to uniformly diffuse light emitted from the light source 31. Particularly, the diffuser plate 50 may diffuse light emitted from the plurality of light sources 31 within the diffuser plate 50 to eliminate unevenness in brightness caused by the plurality of light sources 31. In other words, the diffuser plate 50 may uniformly emit uneven light from the plurality of light sources 31 to the front side. Stated differently, diffuser plate 50 may spreads light emitted from light source 31 evenly to create a uniform display, ensuring consistency and image quality.

The backlight unit may include the optical sheet 60. The optical sheet 60 may be disposed on a front side of the diffuser plate 50. The optical sheet 60 may be disposed at the rear side of the display panel 10. That is, the optical sheet 60 may be disposed between the display panel 10 and the diffuser plate 50. The optical sheet 60 may be supported by the rear chassis 20.

The optical sheet 60 may be provided to improve the brightness and uniformity of the emitted light. For example, the optical sheet 60 may include a diffusion sheet, a prism sheet, a reflective polarizing sheet, a quantum dot sheet, and/or the like.

It is illustrated that a single optical sheet 60 is provided, but there is no limitation on the number of optical sheets 60. That is, a plurality of optical sheets 60 may be provided.

The display apparatus 1 may include a supporter. The supporter may be disposed between the diffuser plate 50 and the rear chassis 20. The supporter may be attached to the front surface of the rear chassis 20 so as to support the diffuser plate 50. Particularly, the supporter may be attached to the front surface of the rear cover 21 so as to support the diffuser plate 50.

The display apparatus 1 may include an adhesive member 70. The adhesive member 70 may be provided to attach the display panel 10 to the rear chassis 20. The adhesive member 70 may be disposed between the display panel 10 and the rear chassis 20.

A plurality of the adhesive members 70 may be provided. Each of the plurality of adhesive members 70 may extend in one direction. For example, the plurality of adhesive members 70 may include a first adhesive member 71, a second adhesive member 72, and a third adhesive member 73.

The first adhesive member 71 may attach the upper edge (+Z direction) of the display panel 10 to a bracket support portion 23 to be described later. The first adhesive member 71 may be disposed between the upper edge of the display panel 10 and the bracket support portion 23.

The second adhesive member 72 may attach the left edge (+Y direction) of the display panel 10 to a first guide portion 24 to be described later. The second adhesive member 72 may be disposed between the left edge of the display panel 10 and the first guide portion 24.

The third adhesive member 73 may attach the right edge (−Y direction) of the display panel 10 to a second guide portion 25 to be described later. The third adhesive member 73 may be disposed between the right edge of the display panel 10 and the second guide portion 25.

The display apparatus 1 may include a lower cover 80. The lower cover 80 may cover lower sides of the display panel 10 and the rear chassis 20. The lower cover 80 may be coupled to the lower sides of the display panel 10 and the rear chassis 20.

The display apparatus 1 may include a chassis reinforcing member 90. The chassis reinforcing member 90 may be provided to reinforce the rear chassis 20. Particularly, the chassis reinforcing member 90 may be provided to reinforce the side cover 22 of the rear chassis 20.

In a process of manufacturing the rear chassis 20, the side cover 22 may be formed by bending forward from the rear cover 21. Particularly, each of the plurality of cover portions 22a, 22b, and 22c may be formed by bending forward from the rear cover 21. Thereafter, the plurality of cover portions 22a, 22b, and 22c may be attached to each other so as to be connected to each other.

That is, each of the plurality of cover portions 22a, 22b, and 22c may be formed separately and then connected to each other through a separate bonding process. Therefore, a connection point between one of the plurality of cover portions 22a, 22b, and 22c and one cover portion adjacent thereto may have relatively weak strength. In other words, a corner of the side cover 22 may have relatively weak strength.

The chassis reinforcing member 90 may be disposed at a corner of the side cover 22. Particularly, the chassis reinforcing member 90 may be provided on an inner side of the side cover 22 and may be positioned at a corner of the side cover 22. With the configuration, the chassis reinforcing member 90 may come into contact with inner surfaces of one of the plurality of cover portions 22a, 22b, and 22c and a cover portion adjacent thereto. That is, the chassis reinforcing member 90 may cover the corner of the side cover 22 and may reinforce the side cover 22.

A plurality of chassis reinforcing members 90 may be provided. Each of the plurality of chassis reinforcing members 90 may be provided in a shape corresponding to a corner of the rear chassis 20. In other words, each of the plurality of chassis reinforcing members 90 may be provided in a shape corresponding to the corner of the side cover 22. For example, the plurality of chassis reinforcing members 90 may include a first chassis reinforcing member 91 and a second chassis reinforcing member 92.

The first chassis reinforcing member 91 may be disposed at an upper left corner (+Y direction) of the rear chassis 20. Particularly, the first chassis reinforcing member 91 may be disposed at an upper left corner (+Y direction) of the side cover 22. The first chassis reinforcing member 91 may come into contact with an inner surface of the first cover portion 22a and an inner surface of the second cover portion 22b. Accordingly, the first chassis reinforcing member 91 may cover the upper left corner (+Y direction) of the side cover 22.

The second chassis reinforcing member 92 may be disposed at an upper right corner (−Y direction) of the rear chassis 20. Particularly, the second chassis reinforcing member 92 may be disposed at an upper right corner (−Y direction) of the side cover 22. The second chassis reinforcing member 92 may come into contact with the inner surface of the first cover portion 22a and an inner surface of the third cover portion 22c. Accordingly, the second chassis reinforcing member 92 may cover the upper right corner (−Y direction) of the side cover 22.

The display apparatus 1 may include a mounting bracket 100. The mounting bracket 100 may be mounted to the rear chassis 20. Particularly, the mounting bracket 100 may be mounted to a corner of the rear chassis 20.

The mounting bracket 100 may be provided to prevent the display panel 10 from colliding with the rear chassis 20. In addition, the mounting bracket 100 may guide the display panel 10 to be seated in a correct position during an assembly process of the display panel 10.

The mounting bracket 100 may include a plastic material. However, there is no particular limitation on the material of the mounting bracket 100.

A plurality of mounting brackets 100 may be provided. For example, the plurality of mounting brackets 100 may include a first mounting bracket 101 and a second mounting bracket 102. The first mounting bracket 101 and the second mounting bracket 102 may have substantially the same configuration, structure, and features.

The first mounting bracket 101 may be mounted on the upper left corner (+Y direction) of the rear chassis 20. The second mounting bracket 102 may be mounted on the upper right corner (−Y direction) of the rear chassis 20.

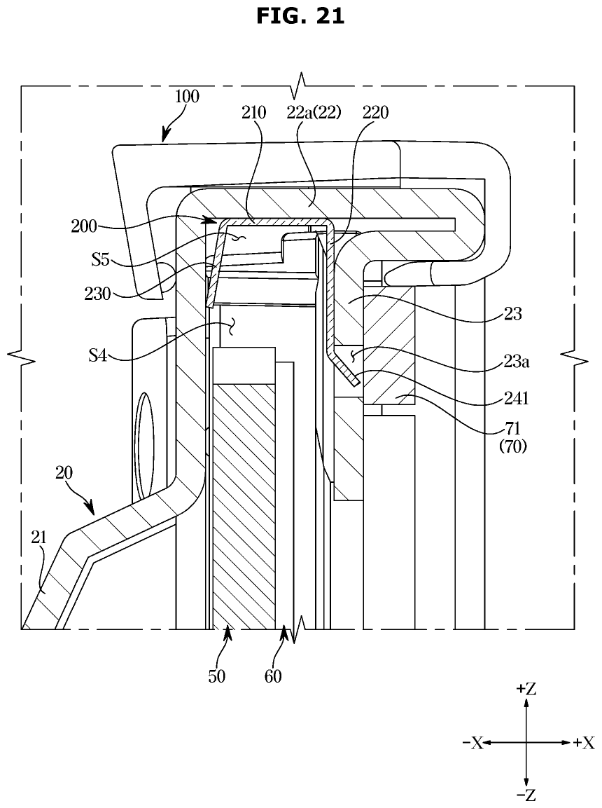

The display apparatus 1 may include a fixing bracket 200. The fixing bracket 200 may be coupled to the rear chassis 20. Particularly, the fixing bracket 200 may be coupled to an upper end of the rear chassis 20. Particularly, the fixing bracket 200 may be coupled to the rear chassis 20 by being inserted into an insertion groove S4 (refer to FIG. 21) to be described later.

The fixing bracket 200 may be provided to fix the optical sheet 60 to the rear chassis 20. Particularly, the fixing bracket 200 may support the optical sheet 60 while being coupled to the rear chassis 20, thereby fixing the optical sheet 60 to the rear chassis 20.

The fixing bracket 200 may include a metal material. However, there is no particular limitation on the material of the fixing bracket 200.

A plurality of fixing brackets 200 may be provided. For example, the plurality of fixing brackets 200 may include a first fixing bracket 201 and a second fixing bracket 202. The first fixing bracket 201 and the second fixing bracket 202 may have substantially the same configuration, structure, and features.

The first fixing bracket 201 may be coupled to the upper end of the left side (+Y direction) of the rear chassis 20. The second fixing bracket 202 may be coupled to the upper end of the right side (−Y direction) of the rear chassis 20.

As described above, the first mounting bracket 101 and the second mounting bracket 102 may have substantially the same configuration, structure, and features. Therefore, for convenience of description, the first mounting bracket 101 will be described below, and a detailed description of the second mounting bracket 102 may be omitted. In addition, the first mounting bracket 101 may be referred to as the mounting bracket 100.

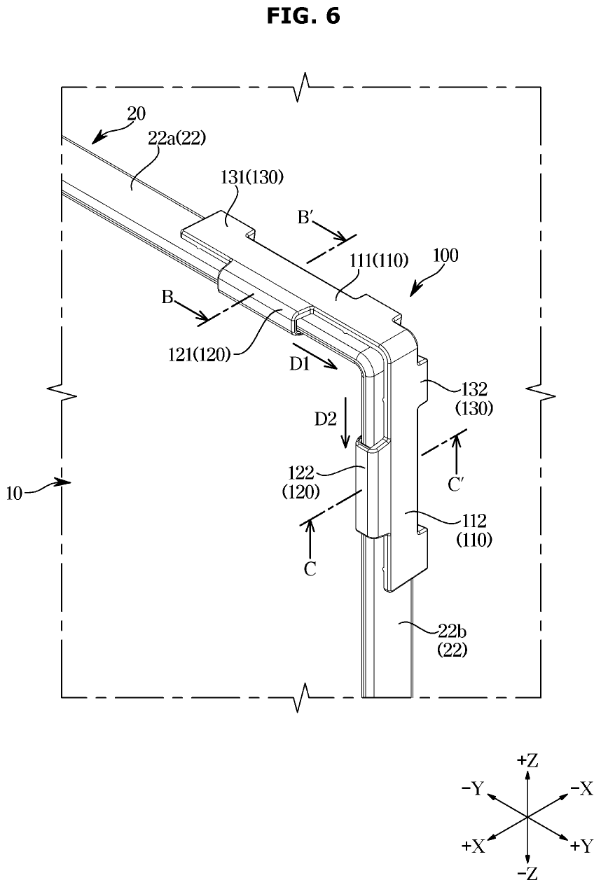

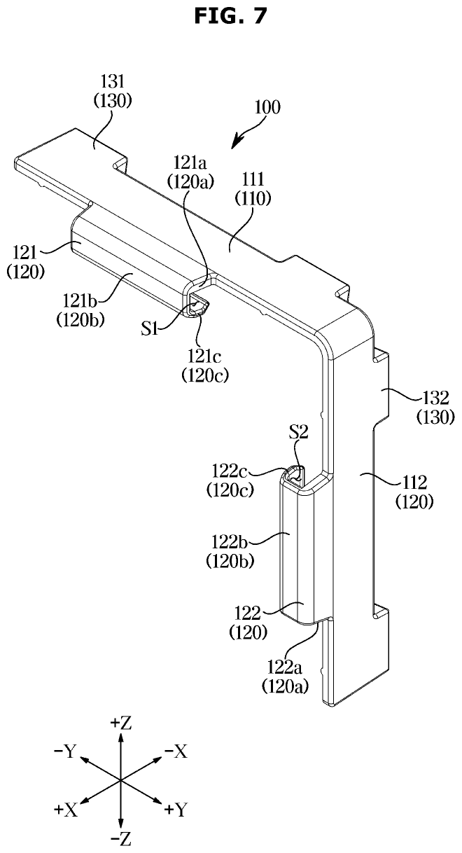

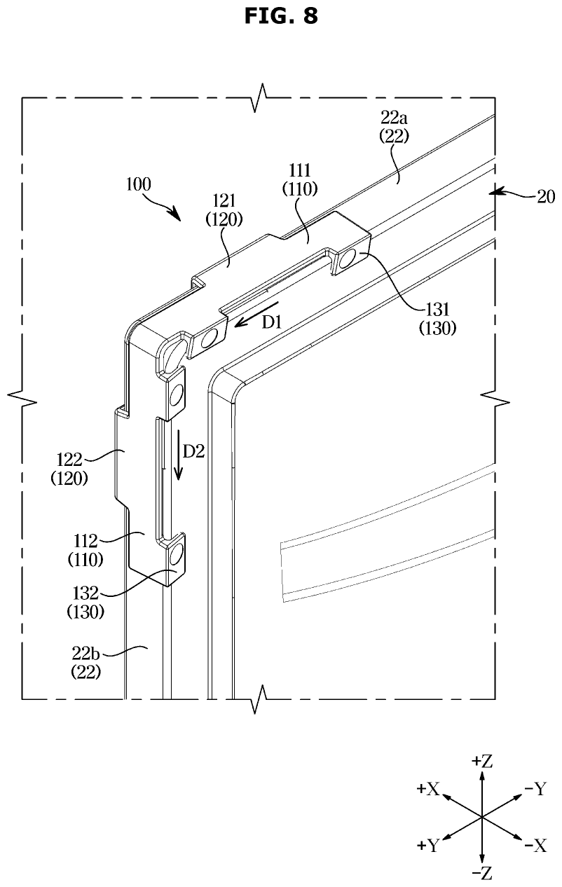

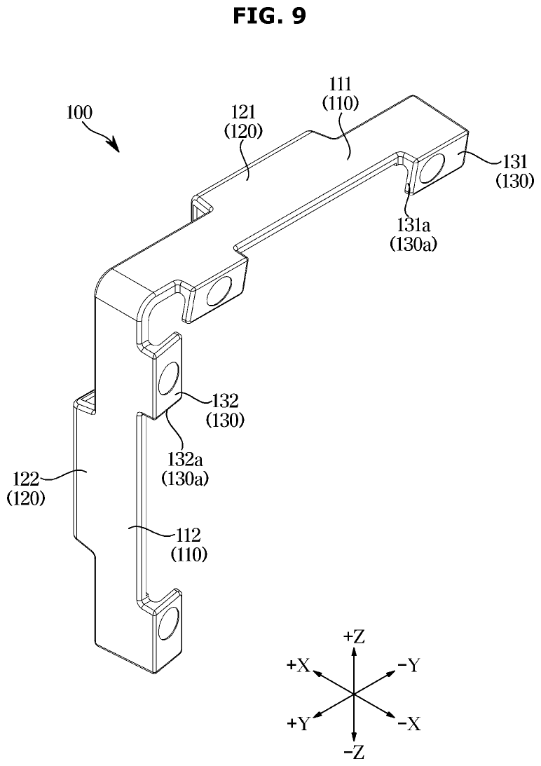

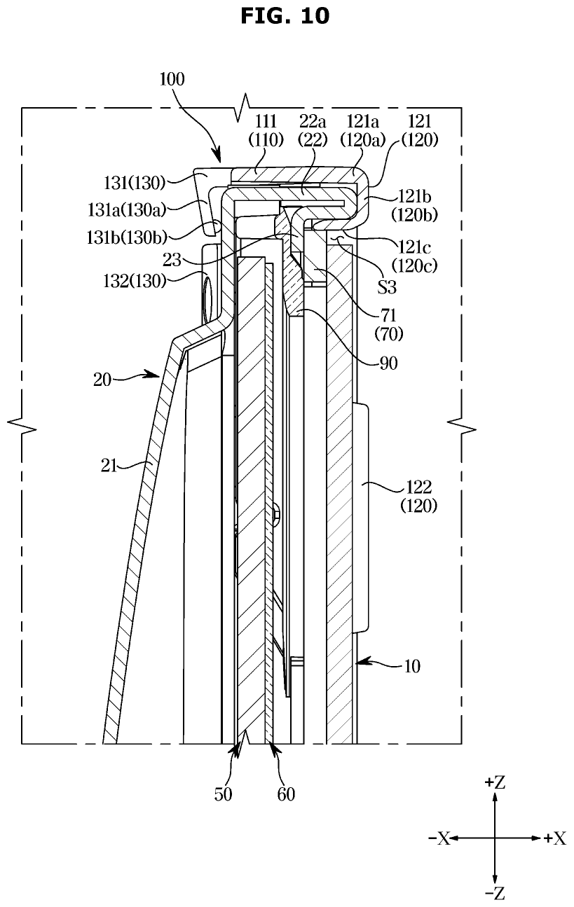

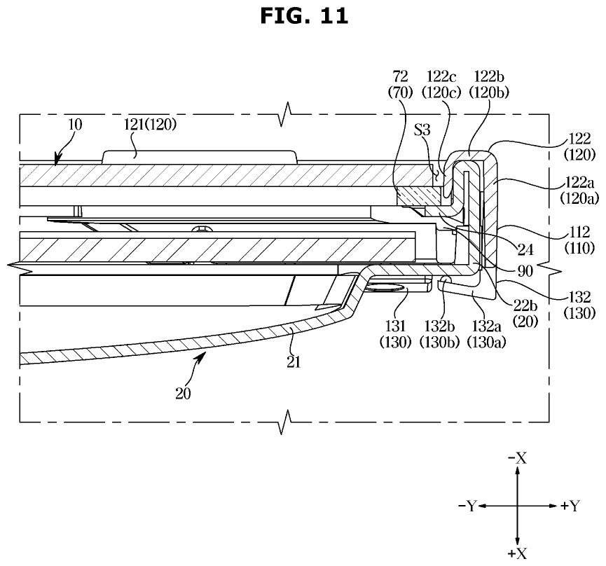

FIG. 6 is an enlarged perspective view of a region A shown in FIG. 1. FIG. 7 is a perspective view of the mounting bracket according to one embodiment. FIG. 8 is an enlarged rear perspective view of the region A shown in FIG. 1. FIG. 9 is a rear perspective view of the mounting bracket according to one embodiment. FIG. 10 is a cross-sectional view taken along line B-B′ shown in FIG. 6. FIG. 11 is a cross-sectional view taken along line C-C′ shown in FIG. 6.

Referring to FIGS. 6 to 11, the mounting bracket 100 may include a bracket body 110. The bracket body 110 may be provided on an outer surface of the side cover 22. That is, the bracket body 110 may come into contact with the outer surface of the side cover 22.

The bracket body 110 may include a first body 111 and a second body 112. The first body 111 and the second body 112 may be connected. The first body 111 may be bent from the second body 112. Alternatively, the second body 112 may be bent from the first body 111.

The first body 111 may be disposed on an outer surface of the first cover portion 22a. That is, the first body 111 may come into contact with the outer surface of the first cover portion 22a. Particularly, the first body 111 may be disposed on an outer surface of a left end (+Y direction) of the first cover portion 22a.

The first body 111 may extend along the first direction D1. For example, the first body 111 may extend along the left and right direction (Y-axis direction).

The second body 112 may be disposed on an outer surface of the second cover portion 22b. That is, the second body 112 may come into contact with the outer surface of the second cover portion 22b. Particularly, the second body 112 may be disposed on an outer surface of an upper end of the second cover portion 22b.

The second body 112 may extend along the second direction D2. For example, the second body 112 may extend along the up and down direction (Z-axis direction).

The mounting bracket 100 may include a hook portion 120. The hook portion 120 may protrude from one end of the bracket body 110. Particularly, the hook portion 120 may protrude from a front end of the bracket body 110.

One end of the side cover 22 may be inserted into the hook portion 120. Particularly, a front end of the side cover 22 may be inserted into the hook portion 120.

The hook portion 120 may include a first hook portion 121 and a second hook portion 122. The first hook portion 121 may protrude from a front end of the first body 111. The second hook portion 122 may protrude from a front end of the second body 112.

A front end of the first cover portion 22a may be inserted into the first hook portion 121. A front end of the second cover portion 22b may be inserted into the second hook portion 122.

The hook portion 120 may include an extension portion 120a extending from one end of the bracket body 110. Particularly, the extension portion 120a may extend forward from the front end of the bracket body 110.

For example, an extension portion 121a of the first hook portion 121 may extend forward from the front end of the first body 111. For example, an extension portion 122a of the second hook portion 122 may extend forward from the front end of the second body 112.

The hook portion 120 may include a first bent portion 120b that is bent from the extension portion 120a. The first bent portion 120b may extend in a direction intersecting a direction in which the extension portion 120a extends. Particularly, the first bent portion 120b may be bent from the extension portion 120a to a direction toward the display panel 10 and may extend toward the display panel 10.

For example, the first bent portion 121b of the first hook portion 121 may be bent downward from the first extension portion 121a and may extend downward. For example, the first bent portion 122b of the second hook portion 122 may be bent in the right direction (−Y direction) from the second extension portion 122a and may extend in the right direction (−Y direction).

The hook portion 120 may include a second bent portion 120c that is bent from the first bent portion 120b. The second bent portion 120c may extend in a direction intersecting a direction in which the first bent portion 120b extends. The second bent portion 120c may extend in a direction parallel to the direction in which the extension portion 120a extends. Particularly, the second bent portion 120c may be bent backward from the first bent portion 120b and may extend backward.

For example, the second bent portion 121c of the first hook portion 121 may be bent backward from the first bent portion 121b and may extend backward. For example, the second bent portion 122c of the second hook portion 122 may be bent backward from the first bent portion 122b and may extend backward.

The extension portion 120a, the first bent portion 120b, and the second bent portion 120c may form cover insertion spaces S1 and S2. The cover insertion spaces S1 and S2 may be provided to allow one end of the side cover 22 to be inserted therein. Particularly, the front end of the side cover 22 may be inserted into the cover insertion spaces S1 and S2.

For example, the extension portion 121a, the first bent portion 121b, and the second bent portion 121c of the first hook portion 121 may form a first cover insertion space S1 into which the front end of the first cover portion 22a is inserted. For example, the extension portion 122a, the first bent portion 122b, and the second bent portion 122c of the second hook portion 122 may form a second cover insertion space S2 into which the front end of the second cover portion 22b is inserted.

The mounting bracket 100 may include a fixing protrusion 130. The fixing protrusion 130 may be provided to fix the mounting bracket 100 to the rear chassis 20. The fixing protrusion 130 may protrude from the other end of the bracket body 110. Particularly, the fixing protrusion 130 may protrude from a rear end of the bracket body 110.

The fixing protrusion 130 may be provided to come into contact with a rear surface of the rear chassis 20. Particularly, the fixing protrusion 130 may be provided to come into contact with a rear surface of the rear cover 21.

The fixing protrusion 130 may include a first fixing protrusion 131 and a second fixing protrusion 132. The first fixing protrusion 131 may protrude from a rear end of the first body 111. The second fixing protrusion 132 may protrude from a rear end of the second body 112.

The fixing protrusion 130 may include an inclined portion 130a. The inclined portion 130a may extend obliquely forward from the other end of the bracket body 110. Particularly, the inclined portion 130a may extend obliquely forward from a rear end of the bracket body 110.

For example, an inclined portion 131a of the first fixing protrusion 131 may extend obliquely forward from the rear end of the first body 111. For example, the first fixing protrusion 131 may extend substantially downward and be inclined forward.

For example, an inclined portion 132a of the second fixing protrusion 132 may extend obliquely forward from the rear end of the second body 112. For example, the second fixing protrusion 132 may extend substantially in the right direction (−Y direction) and be inclined forward.

The fixing protrusion 130 may include a protrusion 130b protruding from the inclined portion 130a. Particularly, the protrusion 130b may protrude forward from the inclined portion 130a. In other words, the protrusion 130b may protrude from the inclined portion 130a toward the rear surface of the rear cover 21. The protrusion 130b may come into contact with the rear surface of the rear cover 21.

For example, the protrusion 131b of the first fixing protrusion 131 may protrude forward from the inclined portion 131a. In other words, the protrusion 131b of the first fixing protrusion 131 may protrude from the inclined portion 131a toward the rear surface of the rear cover 21.

For example, the protrusion 132b of the second fixing protrusion 132 may protrude forward from the inclined portion 132a. In other words, the protrusion 132b of the second fixing protrusion 132 may protrude from the inclined portion 132a toward the rear surface of the rear cover 21.

For example, each of the protrusion 131b of the first fixing protrusion 131 and the protrusion 132b of the second fixing protrusion 132 may come into contact with the rear surface of the rear cover 21.

The protrusion 130b may protrude from an end portion of the inclined portion 130a with respect to a direction in which the inclined portion 130a extends.

For example, the protrusion 131b of the first fixing protrusion 131 may protrude from the end portion of the inclined portion 131a with respect to the direction in which the inclined portion 131a extends. For example, the protrusion 131b of the first fixing protrusion 131 may protrude from a lower end of the inclined portion 131a.

For example, the protrusion 132b of the second fixing protrusion 132 may protrude from the end portion of the inclined portion 132a with respect to the direction in which the inclined portion 132a extends. For example, the protrusion 132b of the second fixing protrusion 132 may protrude from a right end (−Y direction) of the inclined portion 132a.

A plurality of first fixing protrusions 131 may be provided. The plurality of first fixing protrusions 131 may be arranged spaced apart from each other on the rear end of the first body 111. Although two first fixing protrusions 131 are provided in the drawings, there is no particular limitation on the number of first fixing protrusions 131.

A plurality of second fixing protrusions 132 may be provided. The plurality of second fixing protrusions 132 may be arranged spaced apart from each other on the rear end of the second body 112. Although two second fixing protrusions 132 are provided in the drawing, there is no particular limitation on the number of second fixing protrusions 132.

The front end of the side cover 22 may be inserted into the hook portion 120 and the fixing protrusion 130 may come into contact with the rear surface of the rear cover 21. Accordingly, the mounting bracket 100 may be mounted on the rear chassis 20. Particularly, the front end of the first cover portion 22a may be inserted into the first hook portion 121, the front end of the second cover portion 22b may be inserted into the second hook portion 122, and each of the first fixing protrusion 131 and the second fixing protrusion 132 may come into contact with the rear surface of the rear cover 21. Accordingly, the mounting bracket 100 may be mounted on the rear chassis 20.

Referring to FIGS. 10 and 11, a separation space S3 may be formed between the display panel 10 and the side cover 22. Particularly, the separation space S3 may be formed between the upper edge of the display panel 10 and the first cover portion 22a, between the left edge (+Y direction) of the display panel 10 and the second cover portion 22b, and between the right edge (−Y direction) of the display panel 10 and the third cover portion 22c.

At least a portion of the mounting bracket 100 may be disposed in the separation space S3. Particularly, the second bent portion 120c of the hook portion 120 may be disposed in the separation space S3. That is, the second bent portion 120c of the hook portion 120 may be disposed between the display panel 10 and the side cover 22.

For example, the second bent portion 121c of the first hook portion 121 may be disposed between the upper edge of the display panel 10 and the first cover portion 22a. For example, the second bent portion 122c of the second hook portion 122 may be disposed between the left edge (+Y direction) of the display panel 10 and the second cover portion 22b.

With the configuration, the mounting bracket 100 may prevent the display panel 10 from colliding with the rear chassis 20. Particularly, the mounting bracket 100 may prevent the display panel 10 from colliding with the side cover 22. Accordingly, it is possible to prevent cracks in the display panel 10 caused by the collision between the display panel 10 and the rear chassis 20.

In addition, the mounting bracket 100 may guide the display panel 10 to be seated in a correct position during the assembly process of the display panel 10. This will be described in detail later.

As described above, the mounting bracket 100 may perform both the functions of preventing collision between the display panel 10 and the rear chassis 20 and guiding the display panel 10. Therefore, a process of mounting a jig for assembling the display panel 10 or a process of mounting a buffer member for preventing collision between the display panel 10 and the rear chassis 20 may be unnecessary. That is, an efficiency of a manufacturing process of the display apparatus 1 may be increased through the mounting bracket 100, and a total time required for manufacturing the display apparatus 1 may be reduced.

The mounting bracket 100 may be detachably mountable to the rear chassis 20. That is, the mounting bracket 100 may be detachably mountable to the display apparatus 1. Accordingly, a user can mount the mounting bracket 100 to the display apparatus 1 or detach the mounting bracket 100 from the display apparatus 1 depending on the situation.

The configuration, structure and features of the mounting bracket 100 have been described in the above-description. Particularly, the first mounting bracket 101 has been described above, but a detailed description of the second mounting bracket 102 has been omitted.

As described above, the first mounting bracket 101 and the second mounting bracket 102 may have substantially the same configuration, structure, and features. Therefore, the configuration, structure, and features of the mounting bracket 100 described above may be applied not only to the first mounting bracket 101 but also to the second mounting bracket 102. At this time, the expressions such as ‘left end (+Y direction) of the first cover portion 22a’, ‘second cover portion 22b’, ‘right direction (−Y direction)’, ‘right end (−Y direction)’, and ‘left edge (+Y direction) of the display panel 10’ mentioned when describing the mounting bracket 100 may correspond to ‘right end (−Y direction) of the first cover portion 22a’, ‘third cover portion 22c’, ‘left direction (+Y direction)’, ‘left end (+Y direction)’, and ‘right edge (−Y direction) of the display panel 10’, respectively.

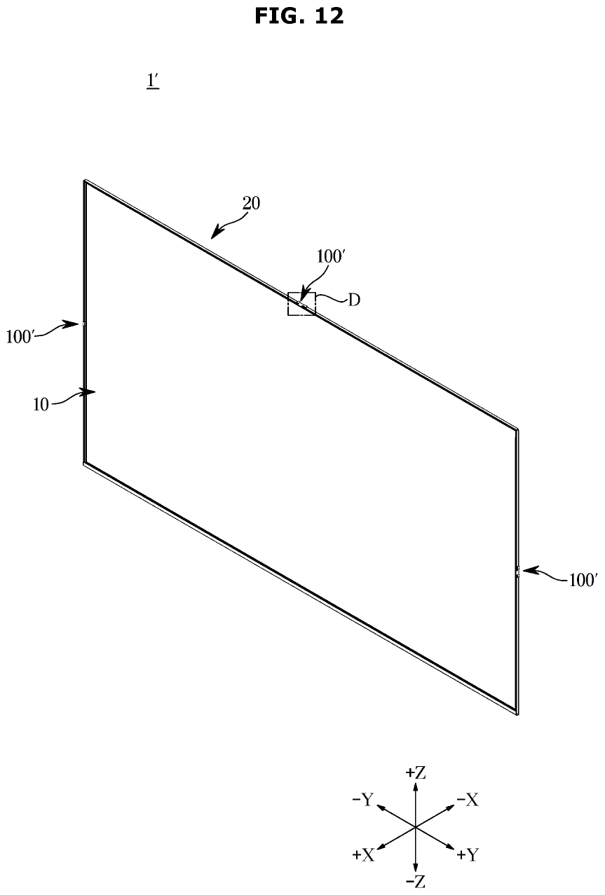

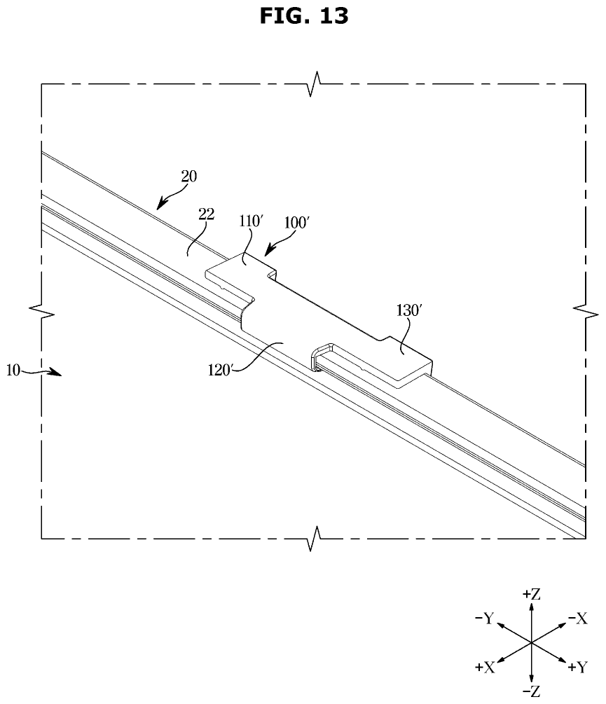

FIG. 12 is a perspective view of a display apparatus according to one embodiment. FIG. 13 is an enlarged perspective view of a region D shown in FIG. 12.

Hereinafter a display apparatus 1′ according to one embodiment of the present disclosure will be described with reference to FIGS. 12 and 13. In describing the display apparatus 1′, components that are substantially the same as those illustrated in FIGS. 1 to 11 are assigned the same reference numerals, and a detailed description thereof may be omitted.

Referring to FIGS. 12 and 13, the display apparatus 1′ may include a mounting bracket 100′. The mounting bracket 100′ may be mounted to a rear chassis 20. Particularly, the mounting bracket 100′ may be mounted to one side of the rear chassis 20.

The mounting bracket 100′ may include a bracket body 110′. The bracket body 110′ may extend in one direction.

The mounting bracket 100′ may include a hook portion 120′ protruding from a front end of the bracket body 110′. A front end of a side cover 22 may be inserted into the hook portion 120′.

The mounting bracket 100′ may include a fixing protrusion 130′ protruding from a rear end of the bracket body 110′. The fixing protrusion 130′ may protrude from a rear end of the side cover 22.

A plurality of mounting brackets 100′ may be provided. Each of the plurality of mounting brackets 100′ may be mounted on one of an upper side (+Z direction), a left side (+Y direction), and a right side (−Y direction) of the rear chassis 20. Although three mounting brackets 100′ are provided in the drawing, there is no particular limitation on the number of mounting brackets 100′.

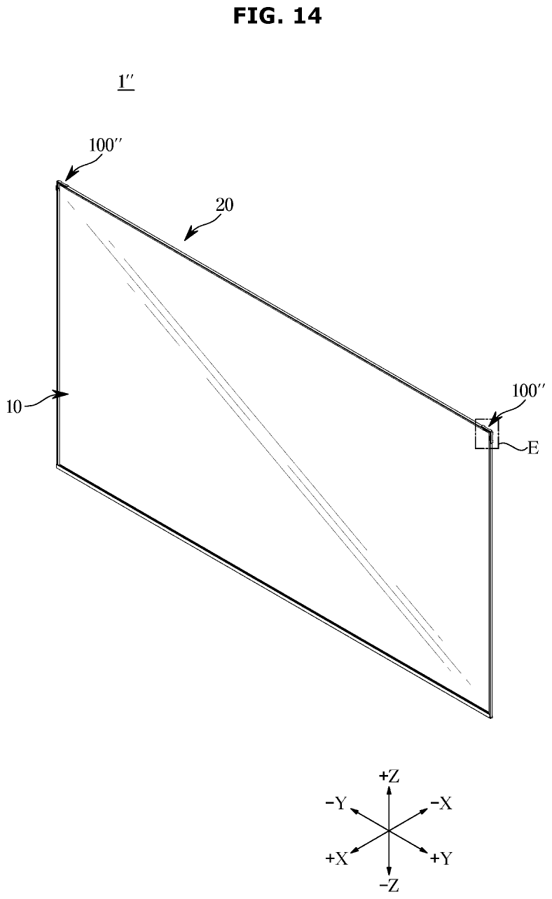

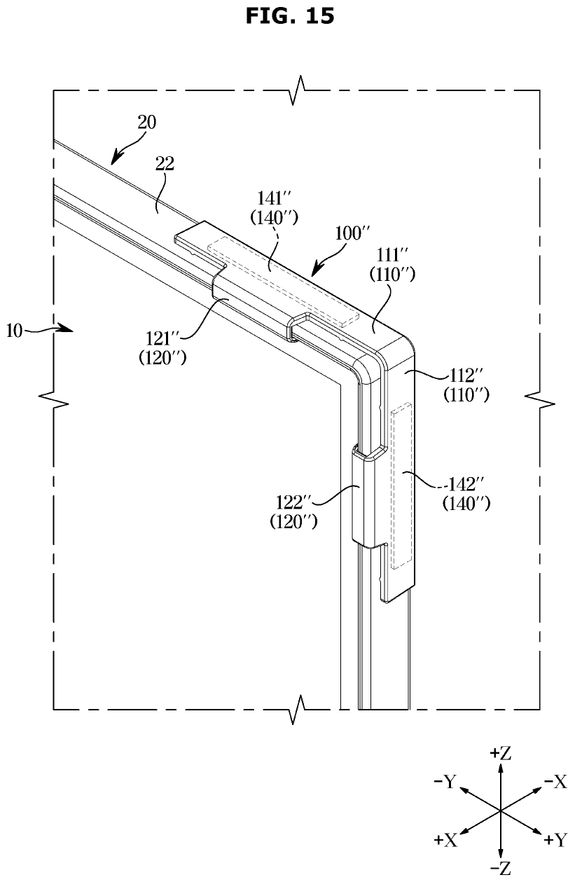

FIG. 14 is a perspective view of a display apparatus according to one embodiment. FIG. 15 is an enlarged perspective view of a region E shown in FIG. 14.

Hereinafter a display apparatus 1″ according to one embodiment of the present disclosure will be described with reference to FIGS. 14 and 15. In describing the display apparatus 1″, components that are substantially the same as those illustrated in FIGS. 1 to 11 are assigned the same reference numerals, and a detailed description thereof may be omitted.

The display apparatus 1″ may include a mounting bracket 100″. The mounting bracket 100″ may be mounted to a rear chassis 20. Particularly, the mounting bracket 100″ may be mounted to a corner of the rear chassis 20.

The mounting bracket 100″ may include a bracket body 110″. The bracket body 110″ may include a first body 111″ and a second body 112″.

The mounting bracket 100″ may include a hook portion 120″. The hook portion 120″ may include a first hook portion 121″ protruding from a front end of the first body 111″ and a second hook portion 122″ protruding from a front end of the second body 112″.

The mounting bracket 100″ may include a magnetic body 140″. The magnetic body 140″ may be provided inside the mounting bracket 100″. Particularly, the magnetic body 140″ may be provided inside the bracket body 110″. For example, the magnetic body 140″ may include a first magnetic body 141″ provided inside the first body 111″ and a second magnetic body 142″ provided inside the second body 112″.

The mounting bracket 100″ may be mounted on the rear chassis 20 due to a magnetic force acting between the side cover 22 and the magnetic body 140″. Therefore, a configuration such as the fixing protrusion may be omitted from the mounting bracket 100″.

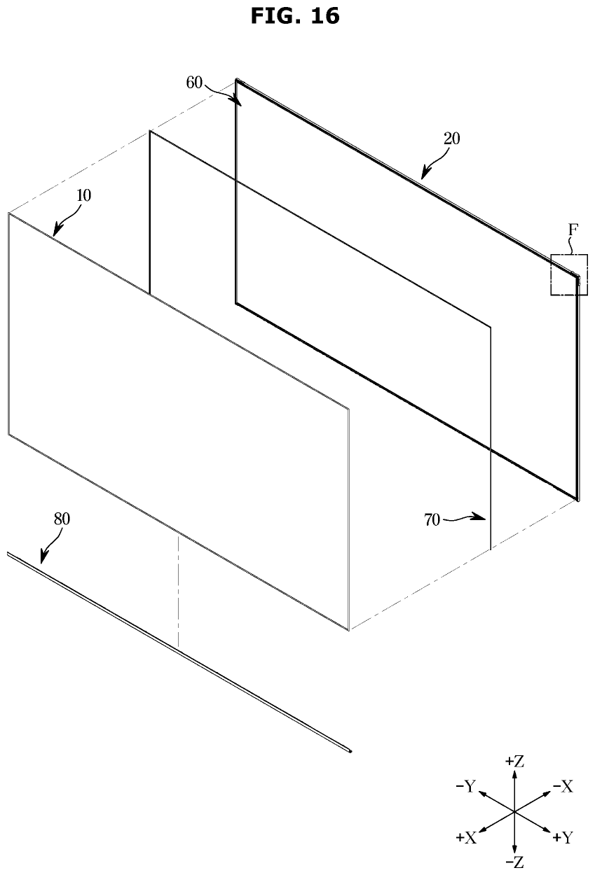

In the above-description, the display apparatuses 1′ and 1″ according to one embodiment of the present disclosure have been described with reference to FIGS. 12 to 15. Hereinafter the display apparatus 1 according to one embodiment of the present disclosure will be described again with reference to FIGS. 16 to 22.

As described above, the first fixing bracket 201 and the second fixing bracket 202 may have substantially the same configuration, structure, and features. Therefore, for convenience of description, the first fixing bracket 201 will be described below, and a detailed description of the second fixing bracket 202 may be omitted. In addition, hereinafter the first fixing bracket 201 may be referred to as the fixing bracket 200.

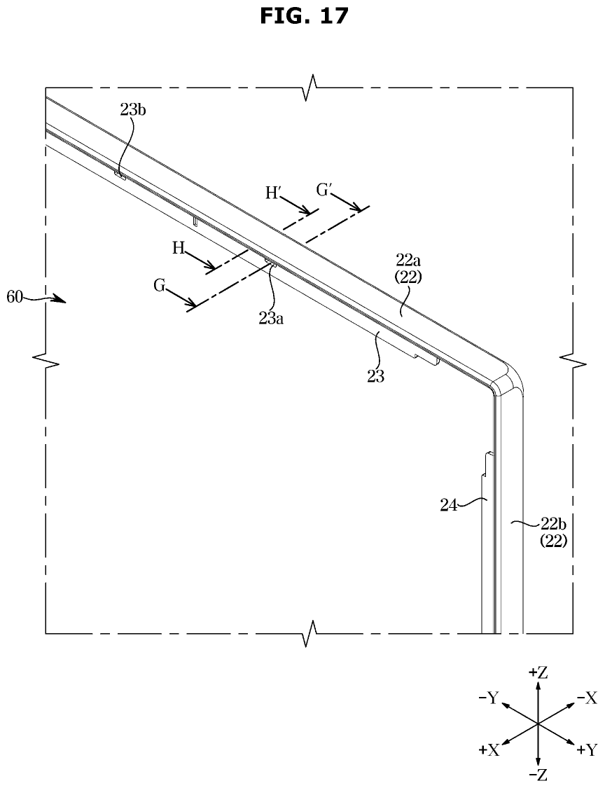

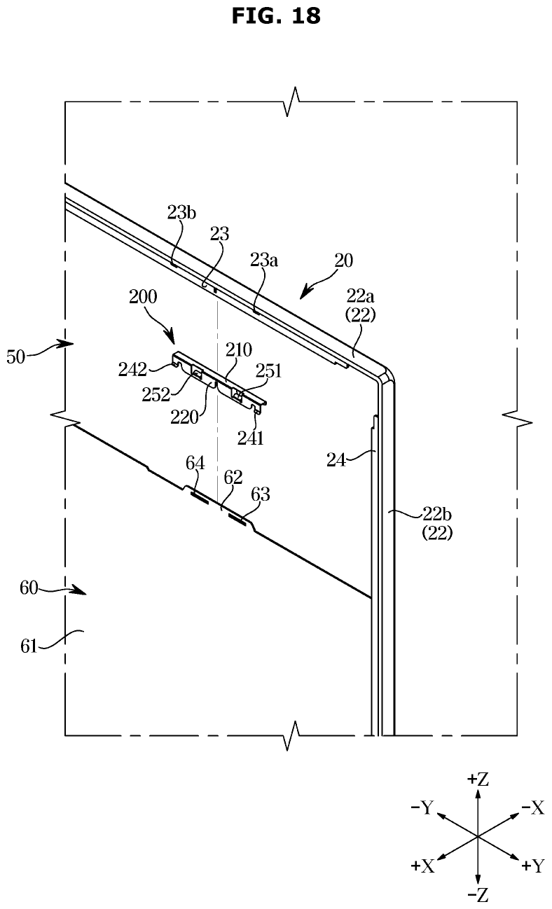

FIG. 16 is an exploded perspective view of the display apparatus according to one embodiment. FIG. 17 is an enlarged perspective view of a region F shown in FIG. 16. FIG. 18 is an exploded perspective view of some components of the display apparatus illustrated in FIG. 17.

Referring to FIGS. 16 to 18, the display panel 10 may be attached to the rear chassis 20 through the adhesive member 70. The lower cover 80 may be coupled to the lower sides of the display panel 10 and the rear chassis 20, thereby covering the lower sides of the display panel 10 and the rear chassis 20.

The optical sheet 60 may be disposed at the rear side of the display panel 10. The optical sheet 60 may be fixed to the rear chassis 20.

The fixing bracket 200 may be provided to fix the optical sheet 60 to the rear chassis 20. Particularly, the fixing bracket 200 may support the optical sheet 60 while being coupled to the rear chassis 20, thereby fixing the optical sheet 60 to the rear chassis 20.

The fixing bracket 200 may be coupled to the rear chassis 20. Particularly, the fixing bracket 200 may be coupled to the upper end of the rear chassis 20.

The rear chassis 20 may include the bracket support portion 23. The bracket support portion 23 may be provided to support the fixing bracket 200.

The bracket support portion 23 may be connected to a portion of the side cover 22. Particularly, the bracket support portion 23 may be connected to a portion of the side cover 22 that covers the upper edge of the display panel 10. That is, the bracket support portion 23 may be connected to the first cover portion 22a.

In the drawing, it is illustrated that the bracket support portion 23 is formed by extending and bending from the first cover portion 22a, but there is no particular limitation on the method of connection between the bracket support portion 23 and the first cover portion 22a. For example, the bracket support portion 23 may be formed by protruding downward from the first cover portion 22a.

The bracket support portion 23 may extend downward from a portion of the side cover 22 that covers the upper edge of the display panel 10. That is, the bracket support portion 23 may extend downward from the first cover portion 22a.

In addition, the bracket support portion 23 may extend along the direction in which a portion of the side cover 22 covering the upper edge of the display panel 10 extends. That is, the bracket support portion 23 may extend along the direction in which the first cover portion 22a extends. For example, the bracket support portion 23 may extend along the left and right direction (Y-axis direction).

The bracket support portion 23 may form an insertion groove S4 together with a portion of the side cover 22 covering the upper edge of the display panel 10 and the rear cover 21. The insertion groove S4 may be provided to allow the fixing bracket 200 to be inserted therein. The fixing bracket 200 may be coupled to the rear chassis 20 by being inserted into the insertion groove S4 (refer to FIG. 21).

The bracket support portion 23 may include a first insertion hole 23a and a second insertion hole 23b. The first insertion hole 23a may be provided to allow a first insertion protrusion 241 to be described later to be inserted therein, and the second insertion hole 23b may be provided to allow a second insertion protrusion 242 to be described later to be inserted therein. The first insertion hole 23a may be formed at a position corresponding to the first insertion protrusion 241, and the second insertion hole 23b may be formed at a position corresponding to the second insertion protrusion 242. The first insertion hole 23a and the second insertion hole 23b may have substantially the same structure and shape.

The first insertion hole 23a and the second insertion hole 23b may be spaced apart from each other along the direction in which a portion of the side cover 22 covering the upper edge of the display panel 10 extends. That is, the first insertion hole 23a and the second insertion hole 23b may be spaced apart from each other along the direction in which the first cover portion 22a extends. For example, the first insertion hole 23a and the second insertion hole 23b may be spaced apart from each other along the left and right direction (Y-axis direction).

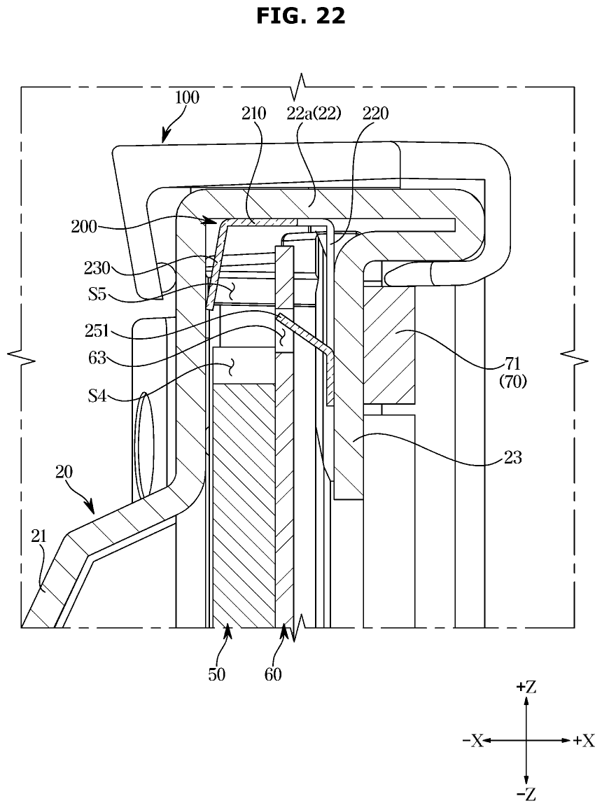

The fixing bracket 200 may form a sheet insertion space S5 into which at least a portion of the optical sheet 60 is inserted. By inserting at least a portion of the optical sheet 60 into the sheet insertion space S5, the fixing bracket 200 may support the optical sheet 60 (refer to FIG. 22).

The optical sheet 60 may include a sheet portion 61 provided in a plate shape and an insertion portion 62 protruding from the sheet portion 61. Particularly, the insertion portion 62 may protrude upward from the sheet portion 61. The insertion portion 62 may be provided to be inserted into the sheet insertion space S5.

The optical sheet 60 may include a third insertion hole 63 and a fourth insertion hole 64. The third insertion hole 63 may be provided to allow a third insertion protrusion 251 to be described later to be inserted therein, and the fourth insertion hole 64 may be provided to allow a fourth insertion protrusion 252 to be described later to be inserted therein. The third insertion hole 63 may be formed at a position corresponding to the third insertion protrusion, and the fourth insertion hole 64 may be formed at a position corresponding to the fourth insertion protrusion. The third insertion hole 63 and the fourth insertion hole 64 may have substantially the same structure and shape.

Each of the third insertion hole 63 and the fourth insertion hole 64 may be formed in the insertion portion 62. The third insertion hole 63 and the fourth insertion hole 64 may be spaced apart from each other along the direction in which a portion of the side cover 22 covering the upper edge of the display panel 10 extends. That is, the third insertion hole 63 and the fourth insertion hole 64 may be spaced apart from each other along the direction in which the first cover portion 22a extends. For example, the third insertion hole 63 and the fourth insertion hole 64 may be spaced apart from each other along the left and right direction (Y-axis direction).

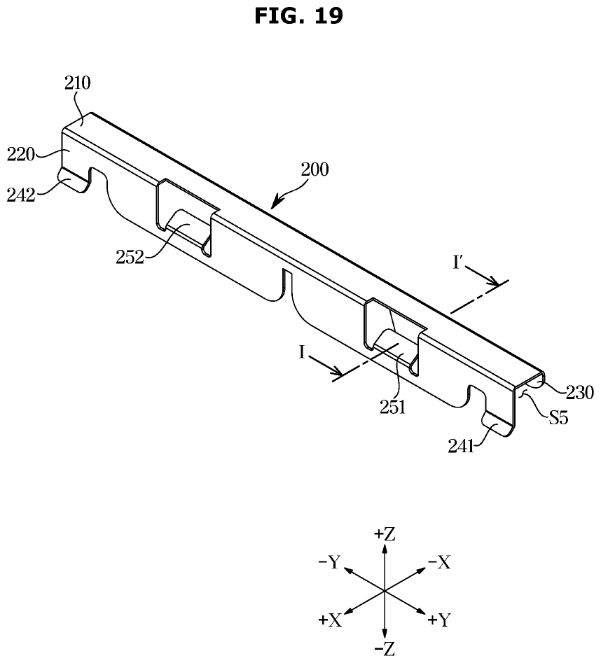

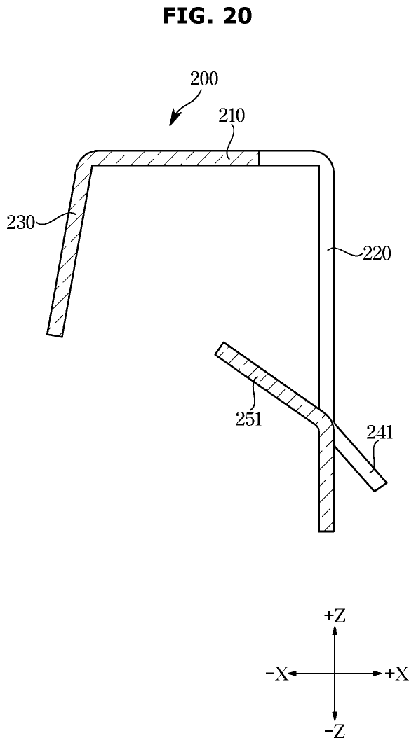

FIG. 19 is a perspective view illustrating a fixing bracket according to one embodiment. FIG. 20 is a cross-sectional view taken along line I-I′ shown in FIG. 19. FIG. 21 is a cross-sectional view taken along line G-G′ shown in FIG. 17. FIG. 22 is a cross-sectional view taken along line H-H′ shown in FIG. 17.

Referring to FIGS. 18 to 22, the fixing bracket 200 may include a first portion 210, a second portion 220, and a third portion 230. The first portion 210, the second portion 220, and the third portion 230 may be formed integrally with each other. The first portion 210, the second portion 220, and the third portion 230 may form the general appearance of the fixing bracket 200.

The first portion 210 may come into contact with the side cover 22. The first portion 210 may be provided on an inner surface of the side cover 22. Particularly, the first portion 210 may be provided on an inner surface of the first cover portion 22a.

The first portion 210 may extend along the direction in which a portion of the side cover 22 covering the upper edge of the display panel 10 extends. That is, the first portion 210 may extend along the direction in which the first cover portion 22a extends. For example, the first portion 210 may extend along the left and right direction (Y-axis direction).

The second portion 220 may be bent from one end of the first portion 210. Particularly, the second portion 220 may be bent downward from a front end of the first portion 210.

The second portion 220 may come into contact with the bracket support portion 23. The second portion 220 may be provided on an inner surface of the bracket support portion 23.

The third portion 230 may be bent from the other end of the first portion 210. Particularly, the third portion 230 may be bent downward from a rear end of the first portion 210.

The third portion 230 may extend obliquely backward from the other end of the first portion 210. Particularly, the third portion 230 may be bent downward from the rear end of the first portion 210 and may extend obliquely backward. With the inclined structure, the fixing bracket 200 may be forcibly inserted into the insertion groove S4. By forcibly inserting the fixing bracket 200 into the insertion groove S4, the fixing bracket 200 may be coupled to the rear chassis 20.

The third portion 230 may come into contact with the front surface of the rear cover 21. Particularly, one end of the third portion 230 along a direction in which the third portion 230 extends may come into contact with the front surface of the rear cover 21.

The first portion 210, the second portion 220, and the third portion 230 may form the sheet insertion space S5 into which at least a portion of the optical sheet 60 is inserted. The sheet insertion space S5 may be formed on the inner sides of the first portion 210, the second portion 220, and the third portion 230.

The fixing bracket 200 may include the first insertion protrusion 241 and the second insertion protrusion 242. The first insertion protrusion 241 may be provided to be inserted into the first insertion hole 23a of the bracket support portion 23, and the second insertion protrusion 242 may be provided to be inserted into the second insertion hole 23b of the bracket support portion 23. The first insertion protrusion 241 and the second insertion protrusion 242 may have substantially the same structure and shape.

Each of the first insertion protrusion 241 and the second insertion protrusion 242 may protrude from the second portion 220 toward the bracket support portion 23. In other words, each of the first insertion protrusion 241 and the second insertion protrusion 242 may protrude forward from the second portion 220.

Each of the first insertion protrusion 241 and the second insertion protrusion 242 may extend obliquely downward from the second portion 220. Particularly, each of the first insertion protrusion 241 and the second insertion protrusion 242 may protrude forward from the second portion 220 and extend obliquely downward.

The first insertion protrusion 241 and the second insertion protrusion 242 may be spaced apart from each other along the direction in which a portion of the side cover 22 covering the upper edge of the display panel 10 extends. That is, the first insertion protrusion 241 and the second insertion protrusion 242 may be spaced apart from each other along the direction in which the first cover portion 22a extends. For example, the first insertion protrusion 241 and the second insertion protrusion 242 may be spaced apart from each other along the left and right direction (Y-axis direction).

The first insertion protrusion 241 may be provided at one end of the second portion 220 along a direction in which the fixing bracket 200 extends. For example, the first insertion protrusion 241 may be provided at the left end (+Y direction) of the second portion 220.

The second insertion protrusion 242 may be provided at the other end of the second portion 220 along the direction in which the fixing bracket 200 extends. For example, the second insertion protrusion 242 may be provided at the right end (−Y direction) of the second portion 220.

The fixing bracket 200 may include the third insertion protrusion 251 and the fourth insertion protrusion 252. The third insertion protrusion 251 may be provided to be inserted into the third insertion hole 63 of the optical sheet 60, and the fourth insertion protrusion 252 may be provided to be inserted into the fourth insertion hole 64 of the optical sheet 60. The third insertion protrusion 251 and the fourth insertion protrusion 252 may have substantially the same structure and shape.

Each of the third insertion protrusion 251 and the fourth insertion protrusion 252 may protrude from the second portion 220 toward the optical sheet 60. In other words, each of the third insertion protrusion 251 and the fourth insertion protrusion 252 may protrude backward from the second portion 220.

Each of the third insertion protrusion 251 and the fourth insertion protrusion 252 may extend obliquely upward from the second portion 220. Particularly, each of the third insertion protrusion 251 and the fourth insertion protrusion 252 may protrude backward from the second portion 220 and extend obliquely upward.

The third insertion protrusion 251 and the fourth insertion protrusion 252 may be spaced apart from each other along the direction in which a portion of the side cover 22 covering the upper edge of the display panel 10 extends. That is, the third insertion protrusion 251 and the fourth insertion protrusion 252 may be spaced apart from each other along the direction in which the first cover portion 22a extends. For example, the third insertion protrusion 251 and the fourth insertion protrusion 252 may be spaced apart from each other along the left and right direction (Y-axis direction).

Each of the third insertion protrusion 251 and the fourth insertion protrusion 252 may be provided between the first insertion protrusion 241 and the second insertion protrusion 242. Particularly, the third insertion protrusion 251 may be provided closer to the first insertion protrusion 241, and the fourth insertion protrusion 252 may be provided closer to the second insertion protrusion 242.

In the drawing, it is illustrated that only the first insertion protrusion 241 is inserted into the first insertion hole 23a of the bracket support portion 23, and the third insertion protrusion 251 is inserted into the third insertion hole 63 of the optical sheet 60. As described above, the first insertion hole 23a, the third insertion hole 63, the first insertion protrusion 241, and the third insertion protrusion 251 may have substantially the same structure and shape as the second insertion hole 23b, the fourth insertion hole 64, the second insertion protrusion 242, and the fourth insertion protrusion 252, respectively. Therefore, a state in which the second insertion protrusion 242 is inserted into the second insertion hole 23b of the bracket support portion 23 may correspond to a state in which the first insertion protrusion 241 is inserted into the first insertion hole 23a of the bracket support portion 23. In addition, a state in which the fourth insertion protrusion 252 is inserted into the fourth insertion hole 64 of the optical sheet 60 may correspond to a state in which the third insertion protrusion 251 is inserted into the third insertion hole 63 of the optical sheet 60.

The configuration, structure and features of the fixing bracket 200 have been described above. Particularly, the first fixing bracket 201 has been described above, but a detailed description of the second fixing bracket 202 has been omitted.

As described above, the first fixing bracket 201 and the second fixing bracket 202 may have substantially the same configuration, structure, and features. Therefore, the configuration, structure, and features of the fixing bracket 200 described above may be applied not only to the first fixing bracket 201 but also to the second fixing bracket 202.

In addition, the bracket support portion 23 may further include a plurality of insertion holes formed at positions corresponding to the second fixing bracket 202. The insertion holes may have substantially the same structure and shape as the first insertion hole 23a and the second insertion hole 23b.

In addition, the optical sheet 60 may further include a plurality of insertion holes formed at positions corresponding to the second fixing bracket 202. The insertion holes may have substantially the same structure and shape as the third insertion hole 63 and the fourth insertion hole 64.

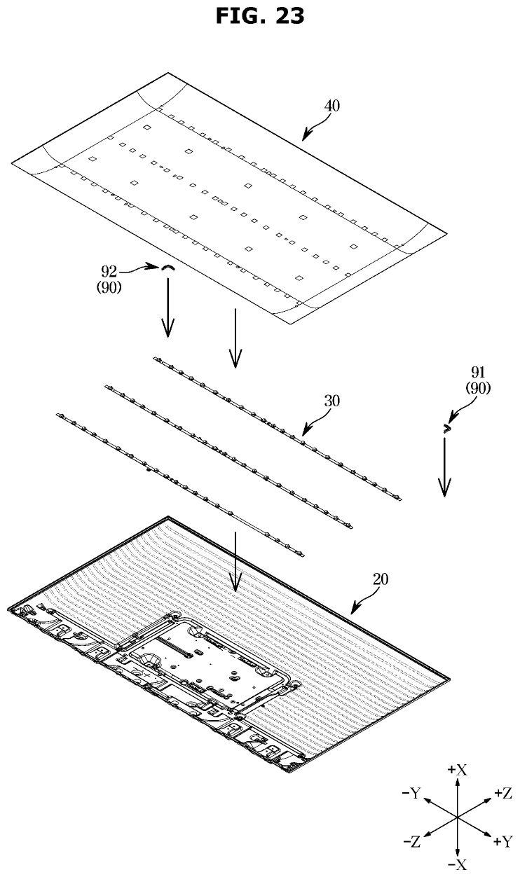

Hereinafter the assembly process of the display apparatus 1 will be described with reference to FIGS. 23 to 31.

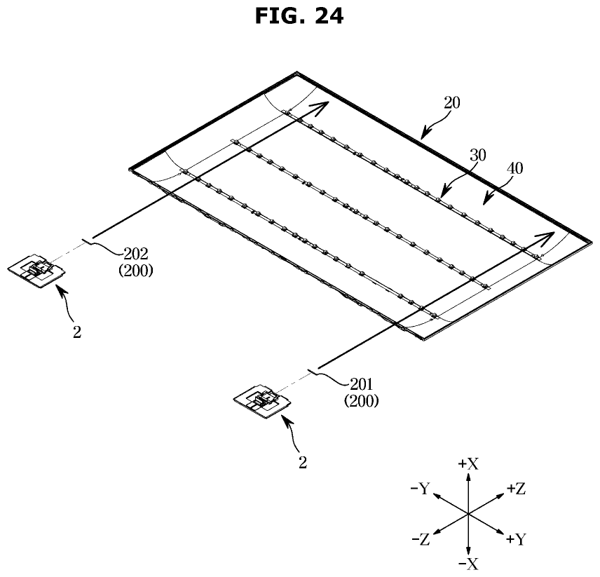

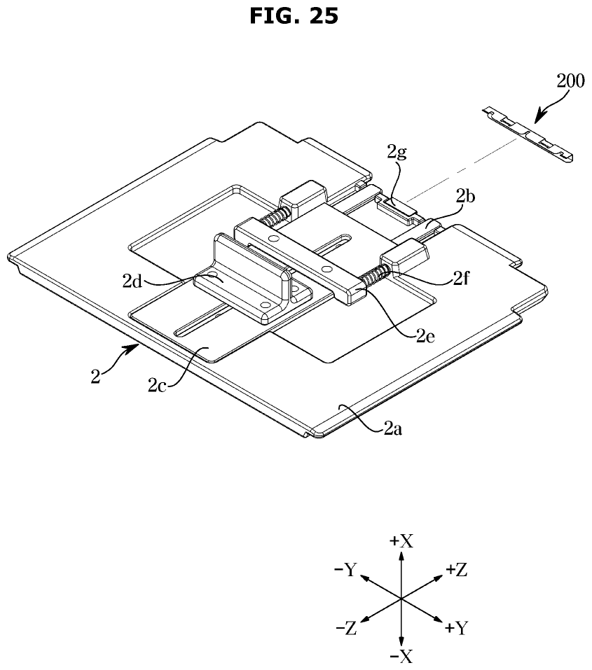

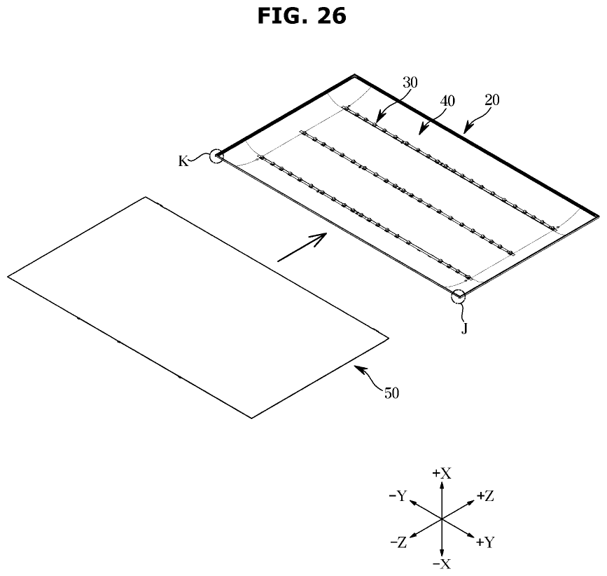

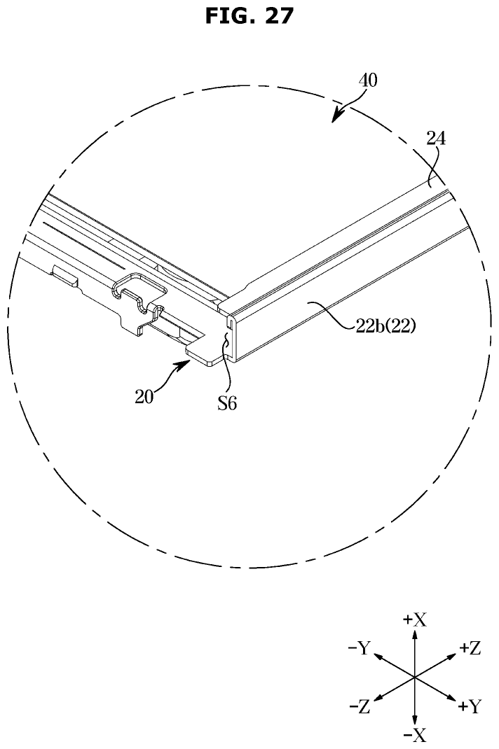

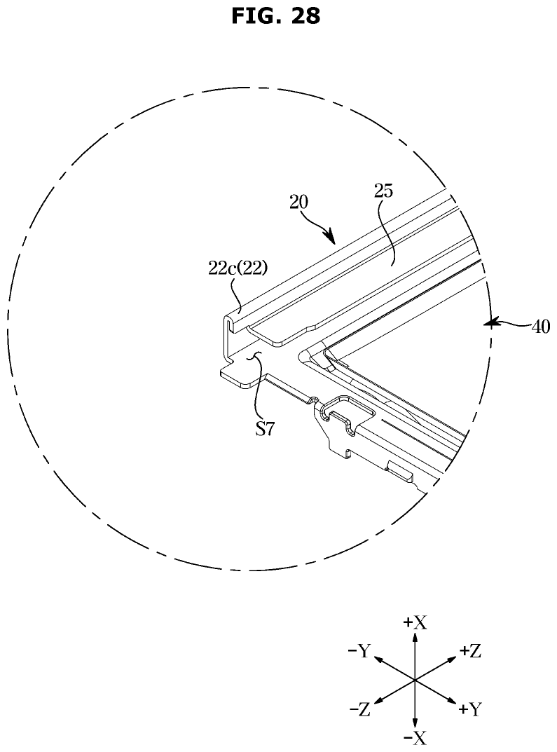

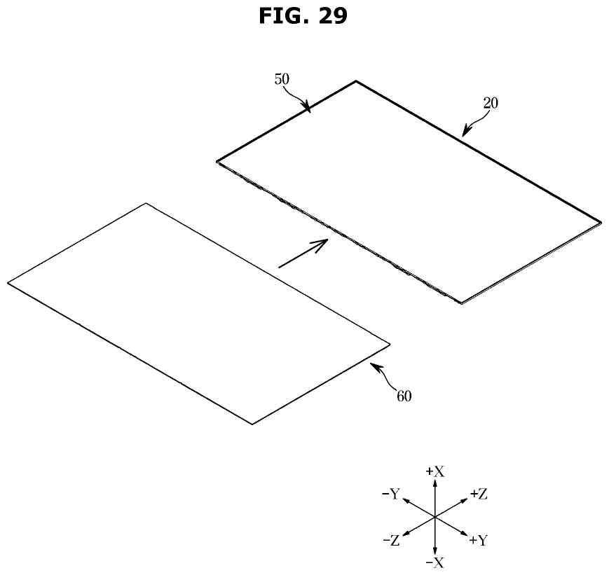

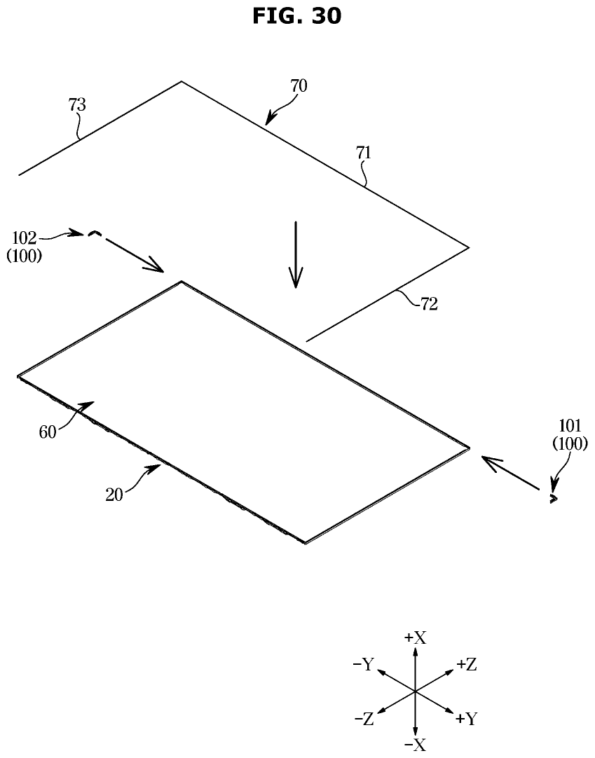

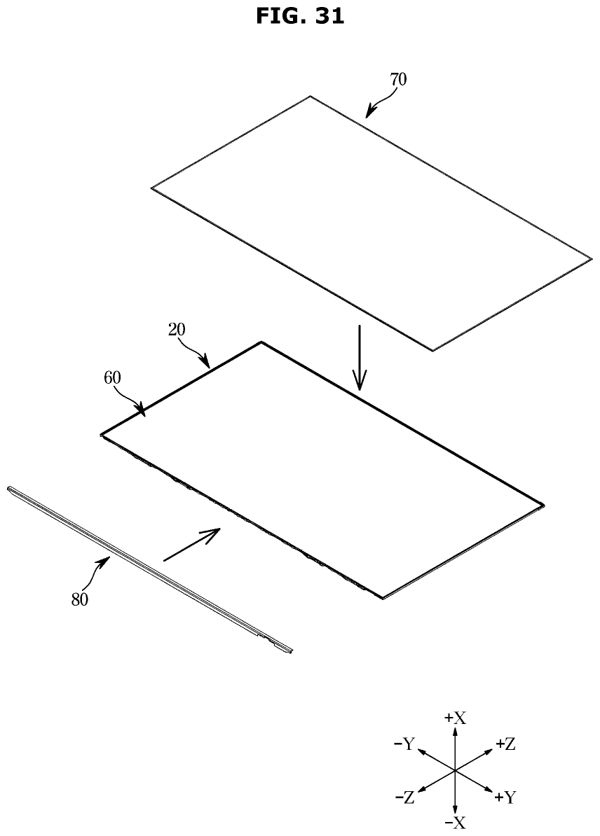

FIG. 23 is a view illustrating a process of assembling the rear chassis, a light source module, the chassis reinforcing member, and a reflective sheet according to one embodiment. FIG. 24 is a view illustrating a process of assembling the fixing bracket according to one embodiment. FIG. 25 is a perspective view illustrating a bracket jig and the fixing bracket according to one embodiment. FIG. 26 is a view illustrating a process of assembling a diffuser plate according to one embodiment. FIG. 27 is an enlarged perspective view of a region J shown in FIG. 26. FIG. 28 is an enlarged perspective view of a region K shown in FIG. 26. FIG. 29 is a view illustrating a process of assembling the reflective sheet according to one embodiment. FIG. 30 is a view illustrating a process of assembling an adhesive member and the mounting bracket according to one embodiment. FIG. 31 is a view illustrating a process of assembling a display panel and a lower cover according to one embodiment.

Referring to FIG. 23, the light source module 30 may be attached to the front surface of the rear chassis 20. Thereafter, the chassis reinforcing member 90 may be disposed at the corner of the rear chassis 20. Particularly, the first chassis reinforcing member 91 may be disposed at the left corner (+Y direction) of the rear chassis 20, and the second chassis reinforcing member 92 may be disposed at the right corner (−Y direction) of the rear chassis 20. Thereafter, the reflective sheet 40 may be attached to the front surface of the rear chassis 20.

However, the assembly order of the light source module 30 and the reflective sheet 40 is not limited thereto. For example, after the reflective sheet 40 is attached to the front surface of the rear chassis 20, the light source module 30 may be attached to the front surface of the reflective sheet 40.

Referring to FIGS. 24 and 25, after the reflective sheet 40 is attached to the front surface of the rear chassis 20, the fixing bracket 200 may be coupled to the upper end of the rear chassis 20. Particularly, the first fixing bracket 201 may be coupled to the upper end of the left side (+Y direction) of the rear chassis 20, and the second fixing bracket 202 may be coupled to the upper end of the right side (−Y direction) of the rear chassis 20.

The fixing bracket 200 may be coupled to the rear chassis 20 via a bracket jig 2. In other words, the fixing bracket 200 may be inserted into the insertion groove S4 via the bracket jig 2 (refer to FIG. 21). Particularly, the fixing bracket 200 may be forcibly inserted into the insertion groove S4 through the bracket jig 2.

The bracket jig 2 may include a jig body 2a, a rail portion 2b extending in one direction on the jig body 2a, a movable plate 2c configured to be movable on the rail portion 2b, a handle portion 2d coupled to the movable plate 2c and provided to be gripped, a block portion 2e provided on the rail portion 2b to limit movement of the movable plate 2c in one direction, an elastic member 2f coupled to the block portion 2e, and a bracket seating portion 2g provided at one end of the rail portion 2b.

First, the fixing bracket 200 may be seated on the bracket seating portion 2g. Thereafter, as an operator manipulates the handle portion 2d, the movable plate 2c may move in one direction on the rail portion 2b. When the movable plate 2c reaches one end of the rail portion 2b, the fixing bracket 200 seated on the bracket seating portion 2g may be inserted into the insertion groove S4 (refer to FIG. 21). Thereafter, the block portion 2e may press the handle portion 2d to the opposite direction to the one direction by an elastic force of the elastic member 2f. Accordingly, the handle portion 2d and the movable plate 2c may return to original positions thereof.

As described above, by coupling the fixing bracket 200 to the rear chassis 20 via the bracket jig 2, the coupling process of the fixing bracket 200 may be further simplified.

As the fixing bracket 200 is inserted into the insertion groove S4, the first insertion protrusion 241 of the fixing bracket 200 may be inserted into the first insertion hole 23a of the bracket support portion 23, and the second insertion protrusion 242 of the fixing bracket 200 may be inserted into the second insertion hole 23b of the bracket support portion 23. This is due to the inclined structure of the first insertion protrusion 241 and the second insertion protrusion 242 and the restoring force caused by the elasticity of the fixing bracket 200 (refer to FIG. 21).

Particularly, as the fixing bracket 200 is inserted into the insertion groove S4, the bracket support portion 23 may press the first insertion protrusion 241 and the second insertion protrusion 242 downward, and accordingly, the first insertion protrusion 241 and the second insertion protrusion 242 may be elastically deformed due to the inclined structures thereof. After the fixing bracket 200 is completely inserted into the insertion groove S4, the first insertion protrusion 241 and the second insertion protrusion 242 may be restored to original shapes thereof by the restoring force, and at the same time, the first insertion protrusion 241 and the second insertion protrusion 242 may be inserted into the first insertion hole 23a and the second insertion hole 23b, respectively (refer to FIG. 21).

Referring to FIGS. 26 to 28, after the fixing bracket 200 is coupled to the rear chassis 20, the diffuser plate 50 may be coupled to the rear chassis 20. Particularly, the upper end of the diffuser plate 50 may be inserted into the insertion groove S4, the left end (+Y direction) of the diffuser plate 50 may be inserted into a first guide groove S6 to be described later, and the right end (−Y direction) of the diffuser plate 50 may be inserted into a second guide groove S7 to be described later. Accordingly, the diffuser plate 50 may be coupled to the rear chassis 20.

The rear chassis 20 may include the first guide portion 24. The first guide portion 24 may be connected to the second cover portion 22b. The first guide portion 24 may extend along the direction in which the second cover portion 22b extends. The first guide portion 24 may form the first guide groove S6 together with the second cover portion 22b and the rear cover 21.

The rear chassis 20 may include the second guide portion 25. The second guide portion 25 may be connected to the third cover portion 22c. The second guide portion 25 may extend along the direction in which the third cover portion 22c extends. The second guide portion 25 may form the second guide groove S7 together with the third cover portion 22c and the rear cover 21.

The diffuser plate 50 may be slidably coupled to the rear chassis 20. As the diffuser plate 50 slides, at least a portion of the diffuser plate 50 may be inserted into the insertion groove S4. Particularly, as the diffuser plate 50 slides, the upper end of the diffuser plate 50 may be inserted into the insertion groove S4.

Each of the first guide portion 24 and the second guide portion 25 may guide the sliding of the diffuser plate 50. In addition, after the display apparatus 1 is completely assembled, each of the first guide portion 24 and the second guide portion 25 may support the diffuser plate 50, thereby coupling the diffuser plate 50 to the rear chassis 20.

Referring to FIGS. 27 to 29, after the diffuser plate 50 is coupled to the rear chassis 20, the optical sheet 60 may be coupled to the rear chassis 20. Particularly, the upper end of the optical sheet 60 may be inserted into the insertion groove S4, the left end (+Y direction) of the optical sheet 60 may be inserted into the first guide groove S6 to be described later, and the right end (−Y direction) of the optical sheet 60 may be inserted into the second guide groove S7 to be described later. Accordingly, the optical sheet 60 may be coupled to the rear chassis 20.

The optical sheet 60 may be slidably coupled to the rear chassis 20. As the optical sheet 60 slides, at least a portion of the optical sheet 60 may be inserted into the insertion groove S4 and the sheet insertion space S5. Particularly, as the optical sheet 60 slides, an upper end of the sheet portion 61 may be inserted into the insertion groove S4, and the insertion portion 62 may be inserted into the sheet insertion space S5. At this time, each of the first guide portion 24 and the second guide portion 25 may guide the sliding of the optical sheet 60.

As the optical sheet 60 slides, the third insertion protrusion 251 of the fixing bracket 200 may be inserted into the third insertion hole 63 of the optical sheet 60, and the fourth insertion protrusion 252 of the fixing bracket 200 may be inserted into the fourth insertion hole 64 of the optical sheet 60. This is due to the inclined structure of the third insertion protrusion 251 and the fourth insertion protrusion 252 and the restoring force caused by the elasticity of the fixing bracket 200 (refer to FIG. 22).

Particularly, as the optical sheet 60 slides into the sheet insertion space S5, the upper end of the optical sheet 60 may press the third insertion protrusion 251 and the fourth insertion protrusion 252 upward, and accordingly, the third insertion protrusion 251 and the fourth insertion protrusion 252 may be elastically deformed due to inclined structures thereof. After the upper end of the optical sheet 60 is completely inserted into the sheet insertion space S5, the third insertion protrusion 251 and the fourth insertion protrusion 252 may be restored to a default position by the restoring force, and at the same time, the third insertion protrusion 251 and the fourth insertion protrusion 252 may be inserted into the third insertion hole 63 and the fourth insertion hole 64, respectively (refer to FIG. 22).

Referring to FIG. 30, after the optical sheet 60 is coupled to the rear chassis 20, the mounting bracket 100 may be mounted to the rear chassis 20. Particularly, the first mounting bracket 101 may be mounted to the left corner (+Y direction) of the rear chassis 20, and the second mounting bracket 102 may be mounted to the right corner (−Y direction) of the rear chassis 20.

The mounting bracket 100 may include the hook portion 120 and the fixing protrusion 130. In order to mount the mounting bracket 100 to the rear chassis 20, the hook portion 120 of the mounting bracket 100 may be firstly hung on one end of the side cover 22. The fixing protrusion 130 may be disposed on the rear surface of the rear cover 21 by utilizing the elasticity of the mounting bracket 100. Accordingly, the mounting bracket 100 may be mounted to the rear chassis 20 (refer to FIGS. 6 and 8).

Referring to FIG. 30, after the optical sheet 60 is coupled to the rear chassis 20, the adhesive member 70 may be disposed on the rear chassis 20. Particularly, the first adhesive member 71 may be disposed on the bracket support portion 23, the second adhesive member 72 may be disposed on the first guide portion 24, and the third adhesive member 73 may be disposed on the second guide portion 25.

Referring to FIG. 31, after the mounting bracket 100 is mounted on the rear chassis 20 and the adhesive member 70 is disposed on the rear chassis 20, the display panel 10 may be disposed on the optical sheet 60. In other words, after the mounting bracket 100 is mounted on the rear chassis 20 and the adhesive member 70 is disposed on the rear chassis 20, the display panel 10 may be disposed on the adhesive member 70. The display panel 10 may be attached to the rear chassis 20 via the adhesive member 70.

When the adhesive member 70 is disposed on the rear chassis 20, the mounting bracket 100 may guide the display panel 10 to be seated in the correct position. The display panel 10 may be seated in a position that is spaced apart from the side cover 22 of the rear chassis 20 by the hook portion 120 of the mounting bracket 100 by a predetermined distance. After the display panel 10 is seated in the correct position, the separation space S3 may be formed between the display panel 10 and the side cover 22. Accordingly, it is possible to prevent the display panel 10 from being cracked caused by the collision between the display panel 10 and the side cover 22 of the rear chassis 20 (refer to FIGS. 10 and 11).

After the display panel 10 is disposed on the optical sheet 60, the lower cover 80 may be coupled to the lower sides of the display panel 10 and the rear chassis 20. Accordingly, the lower cover 80 may cover the lower sides of the display panel 10 and the rear chassis 20.

A display apparatus 1 according to one embodiment may include a display panel 10, a rear chassis 20 supporting the display panel 10 and including a rear cover 21 covering a rear side of the display panel 10 and a side cover 22 protruding rom an edge of the rear cover 21 and covering an edge of the display panel 10, and a mounting bracket 100 mounted on the rear chassis 20. The mounting bracket 100 may include a bracket body 110 on an outer surface of the side cover 22, a hook portion 120 protruding from a first end of the bracket body 110 and configured to receive a portion of the side cover 22, and a fixing protrusion 130 protruding from a second end of the bracket body 110 and configured to contact a rear surface of the rear cover 21 to fix the mounting bracket 100 to the rear chassis 20.

The fixing protrusion 130 may include an inclined portion 130a extending obliquely from the second end of the bracket body 110.

The fixing protrusion 130 may further include a protrusion 130b protruding from the inclined portion 130a toward the rear surface of the rear cover 21.

The protrusion 130b may protrude from one end portion of the inclined portion 130a in a direction in which the inclined portion 130a extends.

The hook portion 120 may include an extension portion 120a extending from an end of the bracket body 110 in a first direction, a first bent portion 120b extending from the extension portion 120a in a second direction intersecting the first direction, and a second bent portion 120c extending from the first bent portion 120b in a third direction parallel to the first direction. The extension portion 120a, the first bent portion 120b, and the second bent portion 120c may define a cover insertion space S1 configured to receive the portion of the side cover 22 to be inserted therein. The second bent portion 120c may be disposed between the display panel 10 and the portion of the side cover 22.

The mounting bracket 100 may be detachably mounted to the rear chassis 20.

The mounting bracket 100 may be mounted on a corner of the rear chassis 20.

The side cover 22 may include a first cover portion 22a extending in a first direction D1, and a second cover portion 22b connected to the first cover portion 22a and extending in a second direction D2 intersecting the first direction D1. The bracket body 110 may include a first body 111 on an outer surface of the first cover portion 22a, and a second body 112 extending from the first body 111 and provided on an outer surface of the second cover portion 22b.

The display apparatus 1 may further include an optical sheet 60 between the display panel 10 and the rear chassis 20, and a fixing bracket 200 coupled to the rear chassis 20 and configured to fix the optical sheet 60 to the rear chassis 20, the fixing bracket 200 defining a sheet insertion space S5 configured to receive at least a portion of the optical sheet 60.

The portion of the side cover 22 is a first portion of the side cover 22. The rear chassis 20 may include a bracket support portion 23 connected to a second portion 22a of the side cover 22 that covers an upper edge of the display panel 10, and supports the fixing bracket 200. The bracket support portion 23, the second portion 22a of the side cover 22, and the rear cover 21 may define an insertion groove S4 configured to receive the fixing bracket 200.

The fixing bracket may include a first portion 210 on an inner surface of the side cover 22, a second portion 220 extending from a first end of the first portion 210 contacting the bracket support portion 23, and a third portion 230 extending from a second end of the first portion 210 contacting a front surface of the rear cover 21.

The third portion 230 may extend obliquely from the second end of the first portion 210.

The fixing bracket 200 may further include an insertion protrusion 241 or 242 extending from the second portion 220 toward the bracket support portion 23. The bracket support portion 23 may include an insertion hole 23a or 23b configured to receive the insertion protrusion 241 or 242.

The fixing bracket 200 may further include an insertion protrusion 251 or 252 extending from the second portion 220 toward the optical sheet 60. The optical sheet 60 may include an insertion hole 63 or 64 hole configured to receive the insertion protrusion 251 or 252.

The insertion protrusion 251 or 252 may extend obliquely upward from the second portion 220.

A display apparatus 1 according to one embodiment may include a display panel 10, a rear chassis 20 supporting the display panel 10 and including a rear cover 21 covering a rear side of the display panel 10 and a side cover 22 protruding forward from an edge of the rear cover 21, and a mounting bracket 100 detachably mountable to the rear chassis 20. The mounting bracket 100 may include a bracket body 110 provided on an outer surface of the side cover 22 and a hook portion 120 protruding from one end of the bracket body 110 and provided to allow one end of the side cover 22 to be inserted therein. At least a portion of the hook portion 120 may be disposed in a separation space between the display panel 10 and the side cover 22.

The display apparatus 1 may further include an optical sheet 60 disposed at the rear side of the display panel 10, and a fixing bracket 200 coupled to the rear chassis 20 and configured to fix the optical sheet 60 to the rear chassis 20, the fixing bracket 200 forming a sheet insertion space S5 provided to allow at least a portion of the optical sheet 60 to be inserted therein.

The rear chassis 20 may include a bracket support portion 23 connected to one portion 22a of the side cover 22 covering an upper edge of the display panel 10, and provided to support the fixing bracket 200, the bracket support portion forming an insertion groove S4 provided to allow the fixing bracket 200 to be inserted therein, together with the one portion 22a of the side cover 22 and the rear cover 21.

At least a portion of the optical sheet 60 may be provided to be inserted into a sheet insertion space S5 as the optical sheet 60 slides. The fixing bracket 200 may include an insertion protrusion protruding backward. The optical sheet 60 may include an insertion hole provided to allow the insertion protrusion to be inserted as the optical sheet 60 slides.

A mounting bracket 100 according to one embodiment may be configured to be detachably mountable to a display apparatus 1 including a display panel 10 and a rear chassis 20 provided at a rear side of the display panel. The mounting bracket 100 may include a bracket body 110, a hook portion 120 including an extension portion 120a extending from one end of the bracket body, a first bent portion 120b bent from the extension portion 120a and extending in a direction intersecting a direction in which the extension portion 120a extends, and a second bent portion 120c bent from the first bent portion 120b and extending in a direction parallel to the direction in which the extension portion 120a extends, and a fixing protrusion 130 protruding from the other end of the bracket body 110.

As is apparent from the above description, a mounting bracket may be configured to prevent a display panel from colliding with a rear chassis. Accordingly, in the display panel, it is possible to prevent cracks caused by the collision between the display panel the rear chassis.

Further, a mounting bracket may guide a display panel to be positioned in a correct position during a manufacturing process of the display panel. Accordingly, a process of assembling the display panel may be made easier.

Additional aspects of the disclosure will be set forth in part in the description which follows and, in part, will be obvious from the description, or may be learned by practice of the disclosure.

While the present disclosure has been particularly described with reference to example embodiments, it should be understood by those of skilled in the art that various changes in form and details may be made without departing from the spirit and scope of the present disclosure.

What is claimed is:

1. A display apparatus comprising:
a display panel;
a rear chassis supporting the display panel, wherein the rear chassis comprises:
a rear cover covering a rear side of the display panel; and
a side cover protruding from an edge of the rear cover and covering an edge of the display panel; and
a mounting bracket mounted on the rear chassis, wherein the mounting bracket comprises:
a bracket body on an outer surface of the side cover;
a hook portion protruding from a first end of the bracket body and configured to receive a portion of the side cover; and
a fixing protrusion protruding from a second end of the bracket body and configured to contact a rear surface of the rear cover to fix the mounting bracket to the rear chassis.

2. The display apparatus of claim 1, wherein the fixing protrusion comprises an inclined portion extending obliquely from the second end of the bracket body.

3. The display apparatus of claim 2, wherein the fixing protrusion further comprises a protrusion protruding from the inclined portion toward the rear surface of the rear cover.

4. The display apparatus of claim 3, wherein the protrusion protrudes from one end portion of the inclined portion in a direction in which the inclined portion extends.

5. The display apparatus of claim 1, wherein the hook portion comprises:
an extension portion extending from an end of the bracket body in a first direction;
a first bent portion extending from the extension portion in a second direction intersecting the first direction; and
a second bent portion extending from the first bent portion in a third direction parallel to the first direction,
wherein the extension portion, the first bent portion, and the second bent portion define a cover insertion space configured to receive the portion of the side cover, and
wherein the second bent portion is between the display panel and the portion of the side cover.

6. The display apparatus of claim 1, wherein the mounting bracket is detachably mounted to the rear chassis.

7. The display apparatus of claim 1, wherein the mounting bracket is mounted on a corner of the rear chassis.

8. The display apparatus of claim 7, wherein the side cover comprises:
a first cover portion extending in a first direction; and
a second cover portion connected to the first cover portion and extending in a second direction intersecting the first direction, and
wherein the bracket body comprises:
a first body on an outer surface of the first cover portion; and
a second body extending from the first body and provided on an outer surface of the second cover portion.

9. The display apparatus of claim 1, further comprising:
an optical sheet between the display panel and the rear chassis; and
a fixing bracket coupled to the rear chassis and configured to fix the optical sheet to the rear chassis, the fixing bracket defining a sheet insertion space configured to receive at least a portion of the optical sheet.

10. The display apparatus of claim 9, wherein
the portion of the side cover is a first portion of the side cover,
wherein the rear chassis comprises a bracket support portion connected to a second portion of the side cover that covers an upper edge of the display panel and supports the fixing bracket, and
wherein the bracket support portion, the second portion of the side cover, and the rear cover define an insertion groove configured to receive the fixing bracket.

11. The display apparatus of claim 10, wherein the fixing bracket comprises:
a first portion on an inner surface of the side cover;
a second portion extending from a first end of the first portion and contacting the bracket support portion; and
a third portion extending from a second end of the first portion and contacting a surface of the rear cover.

12. The display apparatus of claim 11, wherein the third portion extends obliquely from the second end of the first portion.

13. The display apparatus of claim 11, wherein the fixing bracket further comprises an insertion protrusion extending from the second portion toward the bracket support portion, and
wherein the bracket support portion comprises an insertion hole configured to receive the insertion protrusion.

14. The display apparatus of claim 11, wherein the fixing bracket further comprises an insertion protrusion extending from the second portion toward the optical sheet, and
wherein the optical sheet comprises an insertion hole configured to receive the insertion protrusion.

15. The display apparatus of claim 14, wherein the insertion protrusion extends obliquely upward from the second portion.
